(19) United States
(12) Patent Application Publication
(10) Pub. No.: US 2018/0114046 A1
(43) Pub. Date: Apr. 26, 2018

(54) ELECTRONIC APPARATUS

(71) Applicant: KYOCERA CORPORATION, Kyoto (JP)

(72) Inventors: Kenji SHIMADA, Yokohama-shi (JP); Yuto ISHIDA, Yokohama-shi (JP)

(21) Appl. No.: 15/849,447

(22) Filed: Dec. 20, 2017

Related U.S. Application Data
(63) Continuation of application No. PCT/JP2016/068348, filed on Jun. 21, 2016.

(30) Foreign Application Priority Data
Jun. 26, 2015 (JP) 2015-128722

(51) Int. Cl. G06K 9/00

(52) U.S. Cl. CPC G06K 9/001; G06K 9/0008; G06K 9/00013

(57) ABSTRACT

An electronic apparatus is disclosed. An electronic apparatus includes: a touch area on a surface of the electronic apparatus; a fingerprint sensor; and at least one processor. The at least one processor is configured to: execute a first operation of an application; cause the fingerprint sensor to detect a touch of a finger of a user on the touch area; cause the fingerprint sensor to obtain a fingerprint of the finger in response to the detection of the touch; cause the fingerprint sensor to measure a force of the finger to the touch area, and change the first operation in accordance with the force if the fingerprint is identical to a predetermined fingerprint.

### CROSS-REFERENCE TO RELATED APPLICATION

The present is a continuation based on PCT Application No. PCT/JP2016/068348 filed on Jun. 21, 2016, which claims the benefit of Japanese Application No. 2015-128722 filed on Jun. 26, 2015. PCT Application No. PCT/JP2016/068348 is entitled “ELECTRONIC DEVICE, AND OPERATING METHOD AND CONTROL PROGRAM FOR ELECTRONIC DEVICE”, and Japanese Application No. 2015-128722 is entitled “ELECTRONIC APPARATUS AND OPERATING METHOD OF ELECTRONIC APPARATUS”. The contents of which are incorporated by reference herein in their entirety.

### FIELD

Embodiments of the present disclosure relate to electronic apparatuses.

### BACKGROUND

Various techniques concerning electronic apparatuses have been proposed.

### SUMMARY

An electronic apparatus is disclosed.

In one embodiment, an electronic apparatus includes: a touch area on a surface of the electronic apparatus; a fingerprint sensor; and at least one processor. The at least one processor is configured to: execute a first operation of an application; cause the fingerprint sensor to detect a touch of a finger of a user on the touch area; cause the fingerprint sensor to obtain a fingerprint of the finger in response to the detection of the touch; cause the fingerprint sensor to measure a force of the finger to the touch area, and change the first operation in accordance with the force if the fingerprint is identical to a predetermined fingerprint.

In one embodiment, an electronic apparatus includes: a touch area on a surface of the electronic apparatus; a fingerprint sensor; and at least one processor. The at least one processor is configured to: execute an operation of the electronic apparatus; cause the fingerprint sensor to obtain a fingerprint of a finger on the touch area; determine an orientation of the fingerprint relative to the electronic apparatus; and change the operation in accordance with the orientation if the fingerprint is identical to a predetermined fingerprint.

### BRIEF DESCRIPTION OF THE DRAWINGS

FIG. 1 illustrates a perspective view showing an example of the appearance of an electronic apparatus.

FIG. 2 illustrates a front view showing an example of the appearance of the electronic apparatus.

FIG. 3 illustrates a rear view showing an example of the appearance of the electronic apparatus.

FIG. 4 illustrates an example of a fingerprint detection range.

FIG. 5 illustrates a block diagram showing an example of the configuration of the electronic apparatus.

FIG. 6 illustrates an example of a display of the electronic apparatus.

FIG. 7 illustrates an example of the display of the electronic apparatus.

FIG. 8 illustrates examples of a plurality of reference feature point tables.

FIG. 9 illustrates an example of a reference feature point table.

FIG. 10 illustrates an example of the orientation of a finger touching an operation area.

FIG. 11 illustrates an example of the orientation of the finger touching the operation area.

FIG. 12 illustrates an example of the orientation of the finger touching the operation area.

FIG. 13 illustrates an example of the orientation of the finger touching the operation area.

FIG. 14 illustrates an example of the orientation of the finger touching the operation area.

FIG. 15 illustrates an example of the orientation of the finger touching the operation area.

FIG. 16 illustrates an example of a fingerprint detected by a fingerprint sensor.

FIG. 17 illustrates an example of the fingerprint detected by the fingerprint sensor.

FIG. 18 illustrates an example of the fingerprint detected by the fingerprint sensor.

FIG. 19 illustrates an example of the fingerprint detected by the fingerprint sensor.

FIG. 20 illustrates an example of the fingerprint detected by the fingerprint sensor.

FIG. 21 illustrates an example of the fingerprint detected by the fingerprint sensor.

FIG. 22 illustrates an example of the fingerprint detected by the fingerprint sensor.

FIG. 23 illustrates an example of the fingerprint detected by the fingerprint sensor.

FIG. 24 illustrates an example of the display of the electronic apparatus.

FIG. 25 illustrates an example of the display of the electronic apparatus.

FIG. 26 illustrates an example of the display of the electronic apparatus.

FIG. 27 illustrates an example of the display of the electronic apparatus.

FIG. 28 illustrates a flowchart showing an example of the operation of the electronic apparatus.

FIG. 29 illustrates an example of how the electronic apparatus in a portrait orientation is operated by a right hand.

FIG. 30 illustrates an example of how the electronic apparatus in the portrait orientation is operated by a left hand.

FIG. 31 illustrates an example of how the electronic apparatus in a landscape orientation is operated by the right hand.

FIG. 32 illustrates an example of how the electronic apparatus in the landscape orientation is operated by the left hand.

FIG. 33 illustrates an example of how the electronic apparatus in the portrait orientation is operated by the right hand.

FIG. 34 illustrates an example of how the electronic apparatus in the portrait orientation is operated by the left hand.

FIG. 35 illustrates an example of how the electronic apparatus in the landscape orientation is operated by the right hand.

FIG. 36 illustrates an example of how the electronic apparatus in the landscape orientation is operated by the left hand.

FIG. 37 illustrates an example of how the electronic apparatus in the portrait orientation is operated by the right hand.

FIG. 38 illustrates an example of how the electronic apparatus in the landscape orientation is operated by the right hand.

FIG. 39 illustrates an example of a user operation performed on the operation area of the electronic apparatus.

FIG. 40 illustrates an example of the user operation performed on the operation area of the electronic apparatus.

FIG. 41 illustrates an example of the user operation performed on the operation area of the electronic apparatus.

FIG. 42 illustrates an example of the user operation performed on the operation area of the electronic apparatus.

FIG. 43 illustrates an example of the user operation performed on the operation area of the electronic apparatus.

FIG. 44 illustrates an example of the user operation performed on the operation area of the electronic apparatus.

FIG. 45 illustrates an example of how the finger moves on the operation area of the electronic apparatus.

FIG. 46 illustrates an example of the user operation performed on the operation area of the electronic apparatus.

FIG. 47 illustrates an example of the user operation performed on the operation area of the electronic apparatus.

FIG. 48 illustrates an example of the user operation performed on the operation area of the electronic apparatus.

FIG. 49 illustrates an example of the user operation performed on the operation area of the electronic apparatus.

FIG. 50 illustrates an example of the user operation performed on the operation area of the electronic apparatus.

FIG. 51 illustrates an example of the user operation performed on the operation area of the electronic apparatus.

FIG. 52 illustrates a flowchart showing an example of the operation of the electronic apparatus.

FIG. 53 illustrates an example of the display of the electronic apparatus.

### DETAILED DESCRIPTION

<Appearance of Electronic Apparatus>

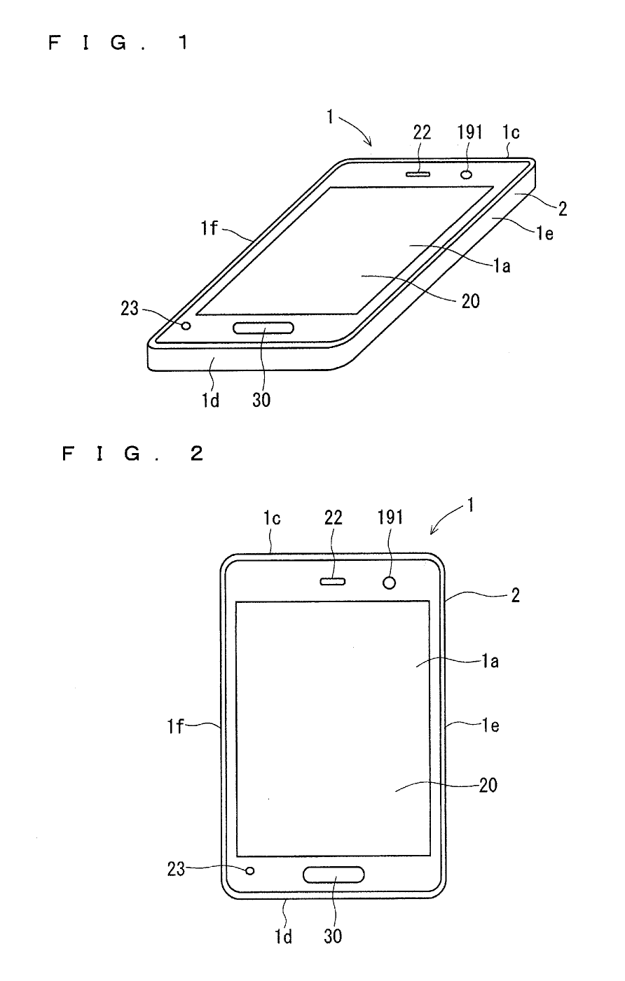

FIGS. 1, 2, and 3 respectively illustrate a perspective view, a front view, and a rear view showing examples of the appearance of an electronic apparatus 1. As illustrated in FIGS. 1 to 3, the electronic apparatus 1 includes an apparatus case 2 having an approximately rectangular plate-like shape in plan view. A front surface 1a of the electronic apparatus 1, namely, a front surface of the apparatus case 2 includes a display area 20 in which a variety of information, such as characters, symbols, and figures, is displayed. A touch panel 130, which will be described below, is stuck to a rear surface of the display area 20. This enables a user to input a variety of information into the electronic apparatus 1 by operating the display area 20 of the front surface 1a of the electronic apparatus 1 with, for example, a finger. The user can also input the variety of information into the electronic apparatus 1 by operating the display area 20 with an operator other than fingers that is, for example, a pen for electrostatic touch panels such as a stylus pen. The touch panel 130 may be stuck to a front surface of the display area 20.

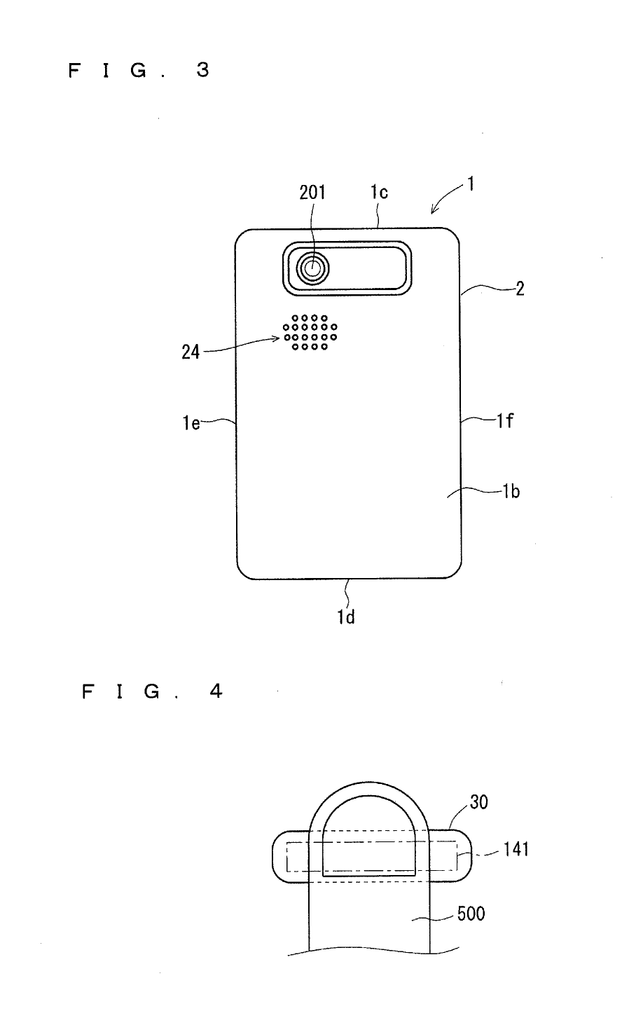

The electronic apparatus 1 has a first side surface 1c, a second side surface 1d, a third side surface 1e, and a fourth side surface 1f. The first side surface 1c and the second side surface 1d oppose each other in a longitudinal direction of the electronic apparatus 1 (the vertical direction in FIG. 2), and the third side surface 1e and the fourth side surface 1f oppose each other in a transverse direction of the electronic apparatus 1 (the horizontal direction in FIG. 2).

A microphone hole 23 and a receiver hole 22 are located in opposite end portions, in the longitudinal direction, of the front surface of the apparatus case 2. The microphone hole 23 is located in one of the opposite end portions closer to the second side surface 1d, and the receiver hole 22 is located in the other one of the opposite end portions closer to the first side surface 1c.

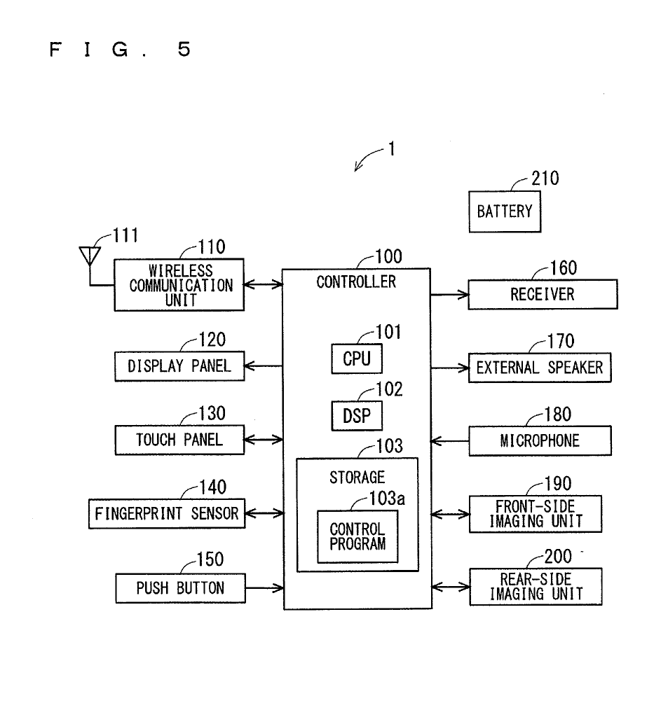

From the end portion closer to the first side surface 1c of the front surface of the apparatus case 2, an imaging lens 191 of a front-side imaging unit 190, which will be described below, is visible. As illustrated in FIG. 3, speaker holes 24 are located in a rear surface 1b of the electronic apparatus 1, namely, a rear surface of the apparatus case 2. From the rear surface of the apparatus case 2, an imaging lens 201 of a rear-side imaging unit 200, which will be described below, is visible.

An operation area 30 to be operated by a finger of the user is located in the end portion closer to the second side surface 1d of the front surface of the apparatus case 2. The operation area 30 is a part of a push button 150, which will be described below. This means that the push button 150 is partially exposed from the end portion closer to the second side surface 1d of the front surface of the apparatus case 2, and the exposed part is the operation area 30. The user can push the push button 150 by pushing the operation area 30. The location and the shape of the operation area 30 are not limited to those illustrated in FIGS. 1 and 2.

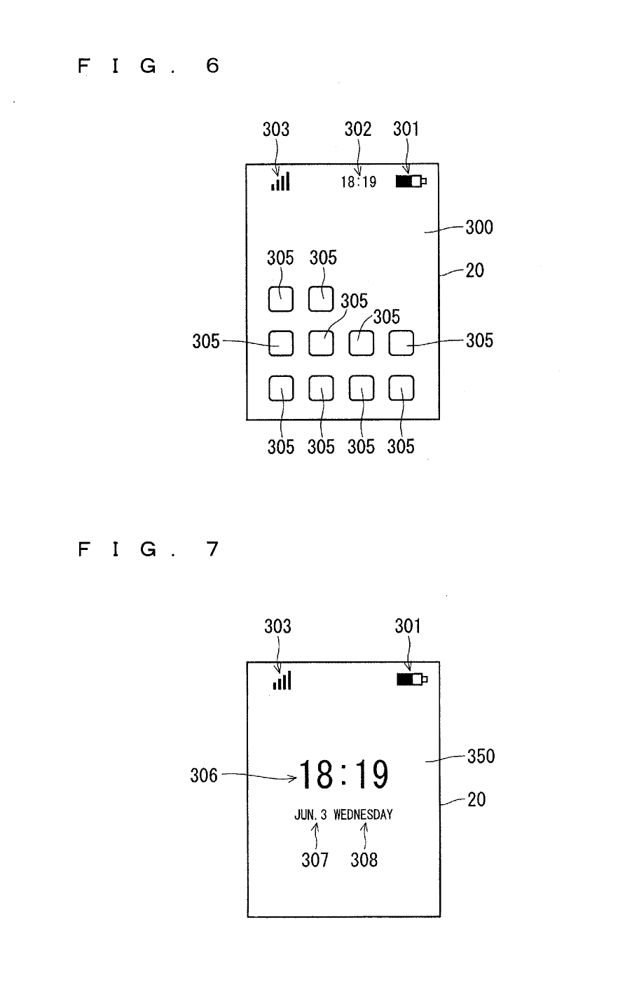

A part of the operation area 30 is a fingerprint detection range 141 of a fingerprint sensor 140, which will be described below. FIG. 4 illustrates an example of the fingerprint detection range 141. The fingerprint sensor 140 can detect a fingerprint of a finger 500 of the user touching the fingerprint detection range 141 included in the operation area 30. The fingerprint detection range 141 may correspond to the operation area 30. The shape of the fingerprint detection range 141 is not limited to that in the example of FIG. 4. The fingerprint detected by the fingerprint sensor 140 may also be referred to as a “detected fingerprint”. In the following description, touching the operation area 30 with the finger includes touching the fingerprint detection range 141 with the finger.

<Electrical Configuration of Electronic Apparatus>

FIG. 5 illustrates a block diagram mainly showing the electrical configuration of the electronic apparatus 1. As shown in FIG. 5, the electronic apparatus 1 includes a controller 100, a wireless communication unit 110, a display panel 120, the touch panel 130, the fingerprint sensor 140, and the push button 150. The electronic apparatus 1 further includes a receiver 160, an external speaker 170, a microphone 180, the front-side imaging unit 190, the rear-side imaging unit 200, and a battery 210. These components of the electronic apparatus 1 are housed in the apparatus case 2.

The controller 100 is a control circuit including processors, such as a central processing unit (CPU) 101 and a digital signal processor (DSP) 102, and a storage 103. The controller 100 can manage the overall operation of the electronic apparatus 1 by controlling the other components of the electronic apparatus 1. The controller 100 may further include a co-processor, such as a system-on-a-chip (SoC), a micro control unit (MCU), and a field-programmable gate array (FPGA), for example. In this case, the controller 100 may perform various types of control by causing the CPU 101 and the co-processor to cooperate with each other, or may perform various types of control by using one of the CPU 101 and the co-processor while switching therebetween.

The storage 103 includes a non-transitory recording medium, such as read only memory (ROM) and random access memory (RAM), readable by the controller 100 (the CPU 101 and the DSP 102). The storage 103 stores various control programs 103a for controlling the operation of the electronic apparatus 1, specifically, the operation of each component of the electronic apparatus 1, such as the wireless communication unit 110 and the display panel 120. The CPU 101 and the DSP 102 execute the various control programs 103a stored in the storage 103 to achieve various functions of the controller 100. The storage 103 may include a non-transitory computer readable recording medium other than the ROM and the RAM. The storage 103 may include, for example, a compact hard disk drive, a solid state drive (SSD), and the like. All or some of the functions of the controller 100 may be performed by a hardware circuit that requires no software in achieving the functions of the hardware circuit.

The plurality of control programs 103a stored in the storage 103 include various applications (application programs). The storage 103 stores, for example, a telephone application for performing calls using a telephone function, a browser for displaying websites, and an e-mail application for creating, reading, transmitting, and receiving e-mails. The storage 103 also stores a camera application for capturing images using the front-side imaging unit 190 and the rear-side imaging unit 200, a map display application for displaying maps, a game application for playing games, such as a puzzle game, in the electronic apparatus 1, and a music playback control application for controlling playback of music data stored in the storage 103.

The wireless communication unit 110 includes an antenna 111. The wireless communication unit 110 can receive, using the antenna 111, a signal transmitted from a mobile phone other than the electronic apparatus 1 or a signal transmitted from a communication apparatus, such as a web server, connected to the Internet, via a base station and the like. The wireless communication unit 110 can perform amplification and down-conversion on the received signal, and output the resultant signal to the controller 100. The controller 100 can perform demodulation and the like on the received signal as input to acquire, for example, a sound signal indicating a voice, music, and the like included in the received signal. The wireless communication unit 110 can also perform up-conversion and amplification on a transmission signal generated by the controller 100 and including a sound signal and the like, and wirelessly transmit the processed transmission signal from the antenna 111. The transmission signal transmitted from the antenna 111 is received, via the base station and the like, by the mobile phone other than the electronic apparatus 1 or the communication apparatus connected to the Internet.

The display panel 120 is, for example, a liquid crystal display panel or an organic EL panel. The display panel 120 can display a variety of information, such as characters, symbols, and figures, through control performed by the controller 100. The display panel 120 is located to face the display area 20 in the apparatus case 2. The information displayed by the display panel 120 appears in the display area 20.

The touch panel 130 can detect an operation performed on the display area 20 with an operator, such as a finger. The touch panel 130 is, for example, a projected capacitive touch panel, and is stuck to the rear surface of the display area 20. When the user performs an operation on the display area 20 with the operator, such as a finger, an electrical signal corresponding to the operation is input from the touch panel 130 into the controller 100. The controller 100 can specify details of the operation performed on the display area 20 based on the electrical signal from the touch panel 130, and perform processing in accordance with the specified details.

The microphone 180 can convert a sound input from the outside of the electronic apparatus 1 into an electrical sound signal, and output the electrical sound signal to the controller 100. The sound from the outside of the electronic apparatus 1 is taken through the microphone hole 23 into the electronic apparatus 1, and input into the microphone 180.

The external speaker 170 is, for example, a dynamic speaker. The external speaker 170 can convert an electrical sound signal from the controller 100 into a sound, and output the sound. The sound output from the external speaker 170 is output through the speaker holes 24 to the outside. The sound output through the speaker holes 24 can be heard even at a location away from the electronic apparatus 1.

The receiver 160 can output a received sound. The receiver 160 is, for example, a dynamic speaker. The receiver 160 can convert an electrical sound signal from the controller 100 into a sound, and output the sound. The sound output from the receiver 160 is output through the receiver hole 22 to the outside. The volume of the sound output through the receiver hole 22 is lower than the volume of the sound output through the speaker holes 24.

The front-side imaging unit 190 includes the imaging lens 191, an image sensor, and the like. The front-side imaging unit 190 can capture a still image and a moving image based on control performed by the controller 100. The rear-side imaging unit 200 includes the imaging lens 201, an image sensor, and the like. The rear-side imaging unit 200 can capture a still image and a moving image based on control performed by the controller 100.

The battery 210 can output power for the electronic apparatus 1. The battery 210 is, for example, a rechargeable battery. The power output from the battery 210 is supplied to various circuits of the electronic apparatus 1, such as the controller 100 and the wireless communication unit 110.

The fingerprint sensor 140 can detect a fingerprint of a finger touching the operation area 30 of the front surface 1a of the electronic apparatus 1. Specifically, the fingerprint sensor 140 has the fingerprint detection range 141 included in the operation area 30, and can detect a fingerprint of a finger touching the fingerprint detection range 141. The fingerprint sensor 140 outputs, as a result of fingerprint detection, a fingerprint image showing the detected fingerprint, for example. The fingerprint sensor 140 detects the fingerprint, for example, using a capacitive sensing method. The fingerprint sensor 140 may detect the fingerprint using a method other than the capacitive sensing method, such as an optical method.

The push button 150 includes, for example, a pressing part that the user presses and a switch pressed by the pressing part. The pressing part has an exposed area exposed from the front surface 1a of the electronic apparatus 1, and the exposed area is the operation area 30. The pressing part pressed by the user presses the switch. This causes the switch to change from an off state to an on state. The switch can output, to the controller 100, a state notification signal indicating whether the switch is in the on state or in the off state. This allows the controller 100 to know whether the push button 150 is in the on state or in the off state.

By operating the operation area 30 with a finger, the user can push the push button 150, and can cause the fingerprint sensor 140 to detect a fingerprint of the finger.

<Operation Modes of Electronic Apparatus>

The electronic apparatus 1 includes, as an operation mode, a sleep mode in which no display is provided in the display area 20 and a normal mode in which a display is provided in the display area 20. In the sleep mode, some components of the electronic apparatus 1, such as the display panel 120, the touch panel 130, and the fingerprint sensor 140, do not operate. This allows the electronic apparatus 1 to consume less power in the sleep mode than in the normal mode.

If no operation is performed on the electronic apparatus 1 for a given period of time or more in the normal mode, the operation mode transitions from the normal mode to the sleep mode. The operation mode also transitions from the normal mode to the sleep mode when a power button (not illustrated) of the electronic apparatus 1 is operated in the normal mode.

On the other hand, when the power button is operated in the sleep mode, the operation mode transitions from the sleep mode to the normal mode. The operation mode also transitions from the sleep mode to the normal mode when the push button 150 is pushed to be in the on state in the sleep mode.

<Display Screen>

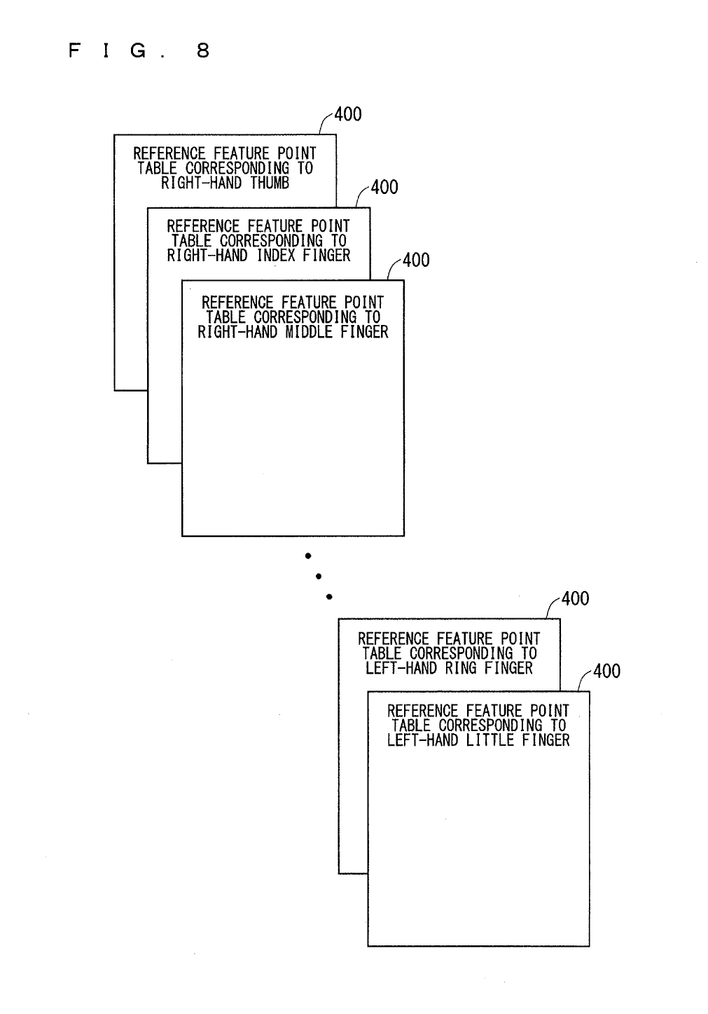

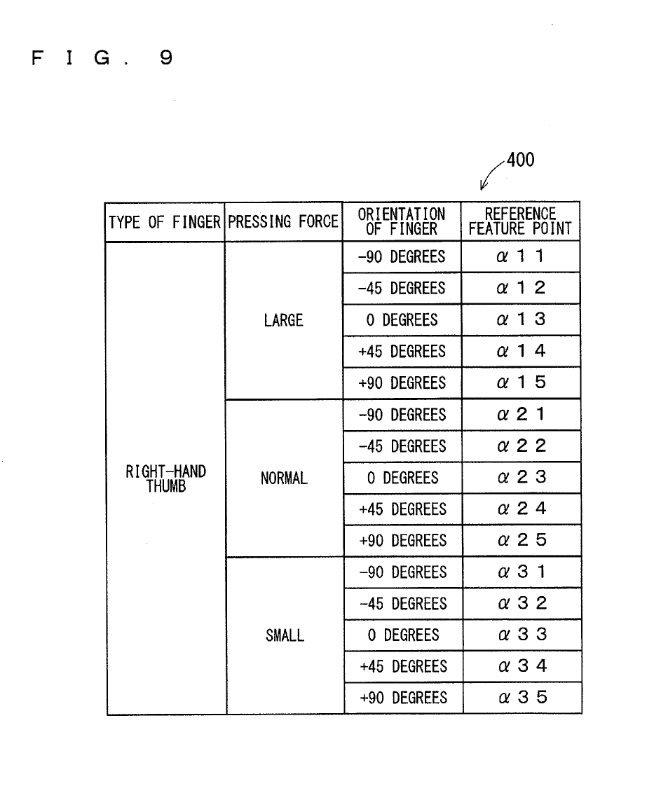

In the normal mode, various display screens are displayed in the display area 20. For example, a home screen or a lock screen is displayed in the display area 20. FIG. 6 illustrates an example of a home screen 300. FIG. 7 illustrates an example of a lock screen 350.

As illustrated in FIG. 6, a battery level icon 301 indicating the current capacity of the battery 210, a current time 302, and a reception status icon (may also be referred to as a radio wave status icon) 303 indicating a radio wave reception status of the wireless communication unit 110 are shown on the home screen 300. Icons (may hereinafter be referred to as “application icons”) 305 corresponding to respective applications to execute the corresponding applications are also shown on the home screen 300. In the example of FIG. 6, ten application icons 305 are shown. When the user performs a predetermined operation (e.g., a tap operation) on any of the application icons 305, the controller 100 reads, from the storage 103, an application corresponding to the application icon 305 on which the operation has been performed, and executes the application. The user can thus cause the electronic apparatus 1 to execute the application corresponding to the application icon 305 on which the operation has been performed by performing the operation on the application icon 305. For example, when the user performs the tap operation on the application icon 305 corresponding to a web browser, the electronic apparatus 1 executes the web browser. When the user performs the tap operation on the application icon 305 corresponding to the camera application, the electronic apparatus 1 executes the camera application.

As illustrated in FIG. 7, the battery level icon 301 and the reception status icon 303 are shown on the lock screen 350 as on the home screen 300. A current time 306, a current date 307, and a current day of week 308 are also shown on the lock screen 350. On the lock screen 350, the time 306 is shown at a location different from the location of the time 302 shown on the home screen 300 to have a larger size than the time 302.

As described above, the application icons 305 are not shown on the lock screen 350, and thus the user cannot cause the electronic apparatus 1 to execute the applications corresponding to the application icons 305 by performing the operation on the lock screen 350. The lock screen 350 is displayed in the display area 20 immediately after the sleep mode is canceled, in other words, immediately after the operation mode transitions from the sleep mode to the normal mode. The lock screen 350 is thus displayed in the display area 20 when the power button or the push button 150 is pushed in the sleep mode in which no display is provided in the display area 20.

When the user performs a predetermined operation on the electronic apparatus 1 during display of the lock screen 350 in the display area 20, a display in the display area 20 transitions from the lock screen 350 to the home screen 300. Detailed description will be made on this point below.

When a display screen other than the lock screen 350 is displayed in the display area 20 in the normal mode, the push button 150 functions as a home button. This means that the home screen 300 is displayed in the display area 20 when the push button 150 is pushed to be in the on state during display of the display screen other than the lock screen 350 in the display area 20.

<User Authentication>

The controller 100 can perform user authentication based on the result of fingerprint detection by the fingerprint sensor 140. The controller 100 functions as an authentication processing unit that can perform the user authentication. The controller 100 performs the user authentication when the lock screen 350 is displayed in the display area 20. When the controller 100 succeeds in the user authentication, a display screen (e.g., the home screen and a display screen displayed when an application is being executed) other than the lock screen 350 is displayed in the display area 20.

In performing the user authentication, the controller 100 first extracts, from the fingerprint image output from the fingerprint sensor 140 as the result of fingerprint detection, a feature point representing features of the detected fingerprint shown by the fingerprint image. The feature point includes, for example, the locations of an end point and a branch point of a ridge line (protrusion) of the fingerprint and the thickness of the ridge line. The controller 100 compares the extracted feature point with a reference feature point stored in the storage 103.

The reference feature point is herein a feature point extracted from a fingerprint image showing a fingerprint of an authorized user (e.g., the owner of the electronic apparatus 1). The electronic apparatus 1 includes a fingerprint registration mode as the operation mode. When a predetermined operation is performed on the display area 20 of the electronic apparatus 1 in the normal mode, the electronic apparatus 1 operates in the fingerprint registration mode. When the authorized user places his/her finger on the operation area 30 (specifically, the fingerprint detection range 141) in the fingerprint registration mode, the fingerprint sensor 140 detects a fingerprint of the finger, and outputs a fingerprint image showing the detected fingerprint. The controller 100 extracts a feature point from the fingerprint image output from the fingerprint sensor 140, and stores the extracted feature point in the storage 103 as the reference feature point. The reference feature point representing features of the fingerprint of the authorized user is thus stored in the storage 103.

A plurality of reference feature points are stored in the storage 103 as will be described below. The controller 100 compares the extracted feature point with each of the plurality of reference feature points stored in the storage 103. The controller 100 determines that the user authentication has succeeded when the extracted feature point is similar to any of the plurality of reference feature points. This means that the controller 100 determines that the user having the fingerprint detected by the fingerprint sensor 140 is the authorized user. On the other hand, the controller 100 determines that the user authentication has failed when the extracted feature point is similar to none of the plurality of reference feature points. This means that the controller 100 determines that the user having the fingerprint detected by the fingerprint sensor 140 is an unauthorized user.

<Plurality of Reference Feature Points>

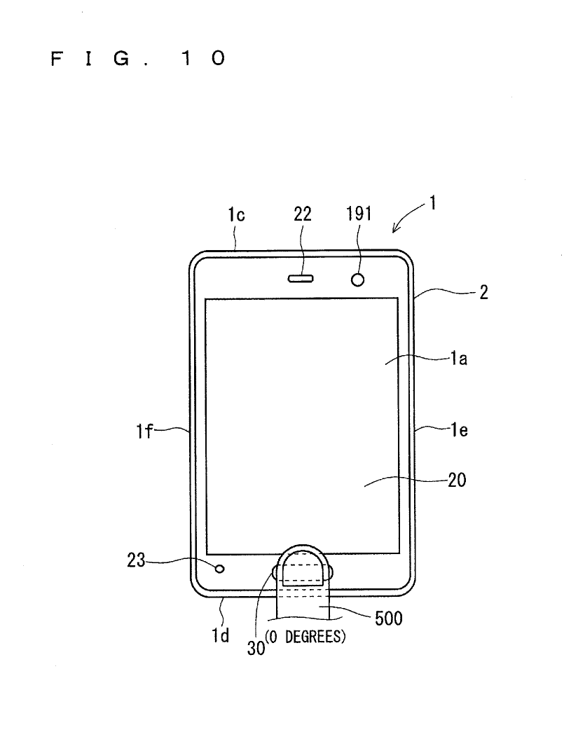

A plurality of reference feature point tables 400 corresponding to respective types of fingers of the authorized user are stored in the storage 103. As illustrated in FIG. 8, ten reference feature point tables 400 corresponding to respective ten fingers of the two hands of the authorized user are stored in the storage 103, for example.

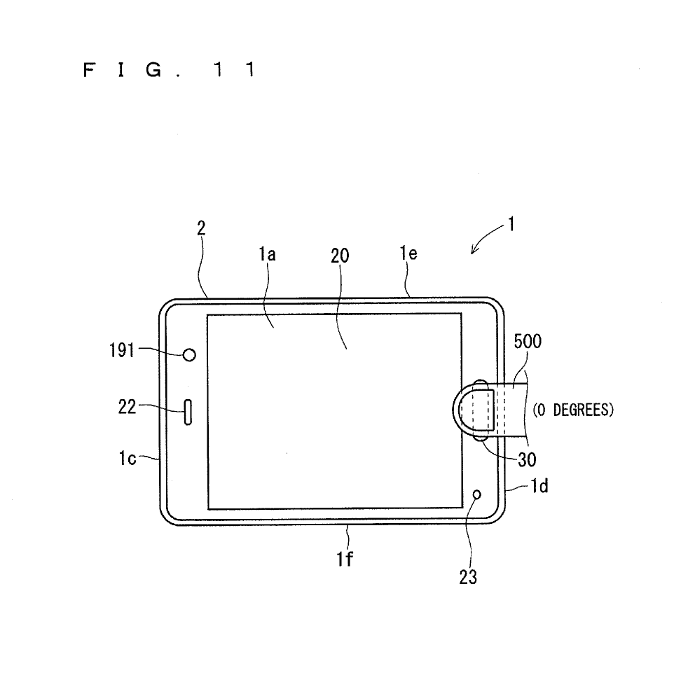

FIG. 9 illustrates an example of a reference feature point table 400 corresponding to a right-hand thumb of the authorized user. Reference feature point tables 400 corresponding to the other types of fingers, such as a right-hand index finger and a left-hand thumb, are each similar to the reference feature point table 400 of FIG. 9.

As illustrated in FIG. 9, the reference feature point table 400 includes a plurality of reference feature points representing features of a fingerprint of a finger (the right-hand thumb in the example of FIG. 9) corresponding to the reference feature point table 400. Specifically, a reference feature point extracted from a fingerprint image showing a fingerprint of a finger acquired by the fingerprint sensor 140 when a force with which the finger presses against the operation area 30 (specifically, the fingerprint detection range 141) is large is registered, in the reference feature point table 400, for each orientation of the finger. The force with which the finger presses against the operation area 30 can also be referred to as the amount of pressure applied to the operation area 30 when the finger touches the operation area 30. A reference feature point extracted from the fingerprint image showing the fingerprint of the finger acquired by the fingerprint sensor 140 when the force with which the finger presses against the operation area 30 is small is also registered, in the reference feature point table 400, for each orientation of the finger. A reference feature point extracted from the fingerprint image showing the fingerprint of the finger acquired by the fingerprint sensor 140 when the force with which the finger presses against the operation area 30 is normal (not large and not small) is also registered, in the reference feature point table 400, for each orientation of the finger. In the reference feature point table 400, each reference feature point is associated with the orientation of the finger and the force with which the finger performs pressing corresponding to the reference feature point.

The orientation of the finger herein refers to the orientation of the finger relative to the electronic apparatus 1. In other words, the orientation of the finger refers to the orientation of the finger touching the operation area 30 relative to the operation area 30. In the example of FIG. 9, five orientations, namely, −90 degrees, −45 degrees, 0 degrees, +45 degrees, and +90 degrees are defined as the orientation of the finger.

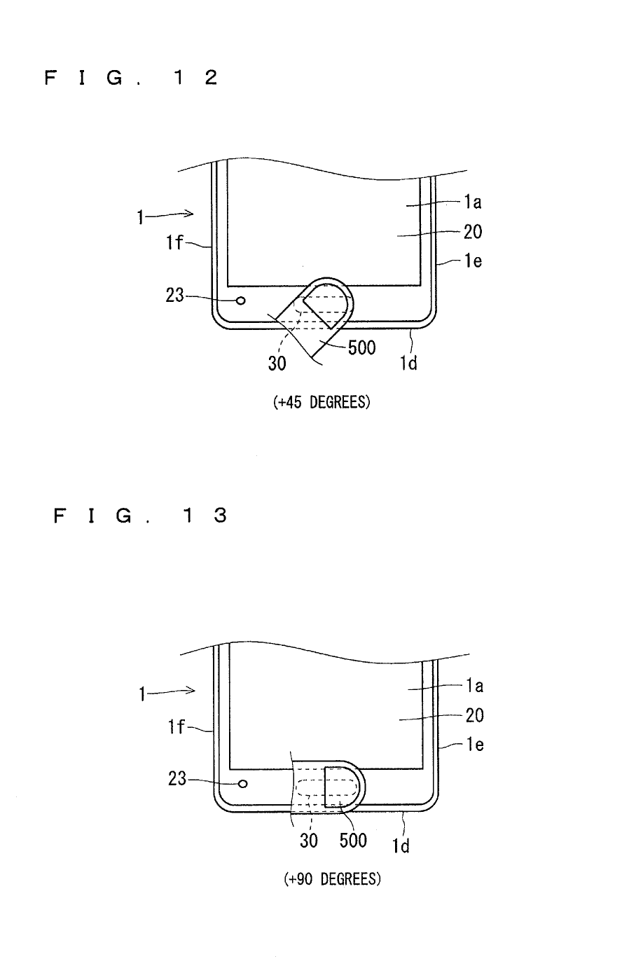

FIG. 10 illustrates a case where the orientation of the finger 500 touching the operation area 30 is 0 degrees. In this example, when the finger 500 touching the operation area 30 (the finger 500 placed on the operation area 30) points in a direction along the longitudinal direction of the display area 20 and toward the receiver hole 22 (toward the first side surface 1c) in a case where the electronic apparatus 1 is viewed from the display area 20 side, the orientation of the finger 500 is defined as 0 degrees. In other words, when the finger 500 touching the operation area 30 points in a direction of 12 o'clock in a case where the electronic apparatus 1 in a portrait orientation with the receiver hole 22 located in an upper portion thereof (with the first side surface 1c located in the upper portion) is viewed from the display area 20 side, the orientation of the finger 500 is defined as 0 degrees. Thus, when the finger 500 touching the operation area 30 points in the direction along the longitudinal direction of the display area 20 and toward the receiver hole 22 (toward the first side surface 1c), the orientation of the finger 500 is defined as 0 degrees even in a case where the electronic apparatus 1 is used in a landscape orientation as illustrated in FIG. 11. That is to say, when the finger 500 touching the operation area 30 points in the direction along the longitudinal direction of the display area 20 and toward the receiver hole 22, the orientation of the finger 500 is defined as 0 degrees regardless of the position (orientation) of the electronic apparatus 1.

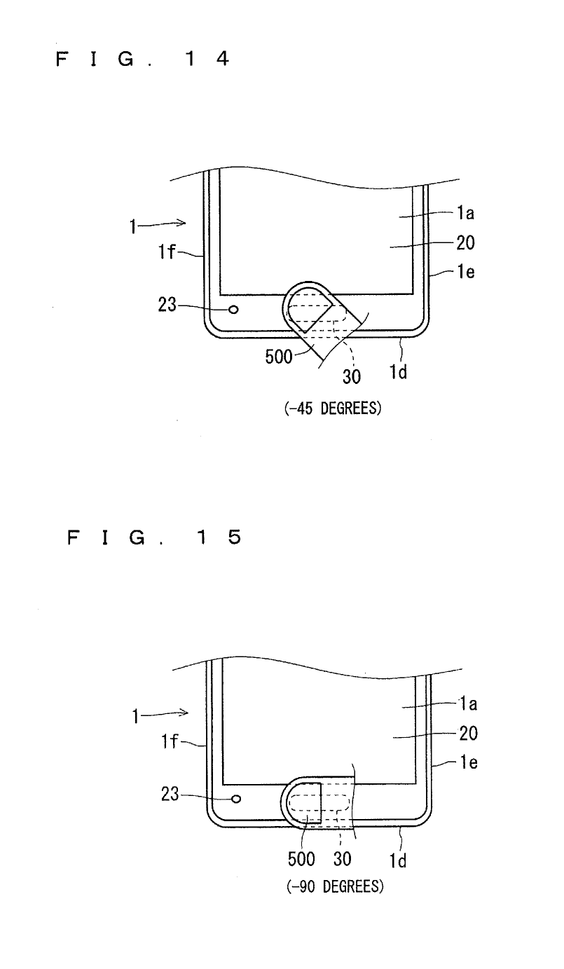

FIGS. 12, 13, 14, and 15 illustrate cases where the orientations of the finger 500 touching the operation area 30 are +45 degrees, +90 degrees, −45 degrees, and −90 degrees, respectively.

As illustrated in FIG. 12, the orientation of the finger 500 when the finger 500 at a 0-degree orientation is rotated 45 degrees in a clockwise direction in a case where the electronic apparatus 1 is viewed from the display area 20 side is defined as +45 degrees. In other words, when the finger 500 touching the operation area 30 points in a direction between 1 o'clock and 2 o'clock in a case where the electronic apparatus 1 in the portrait orientation with the receiver hole 22 located in the upper portion is viewed from the display area 20 side, the orientation of the finger 500 is defined as +45 degrees.

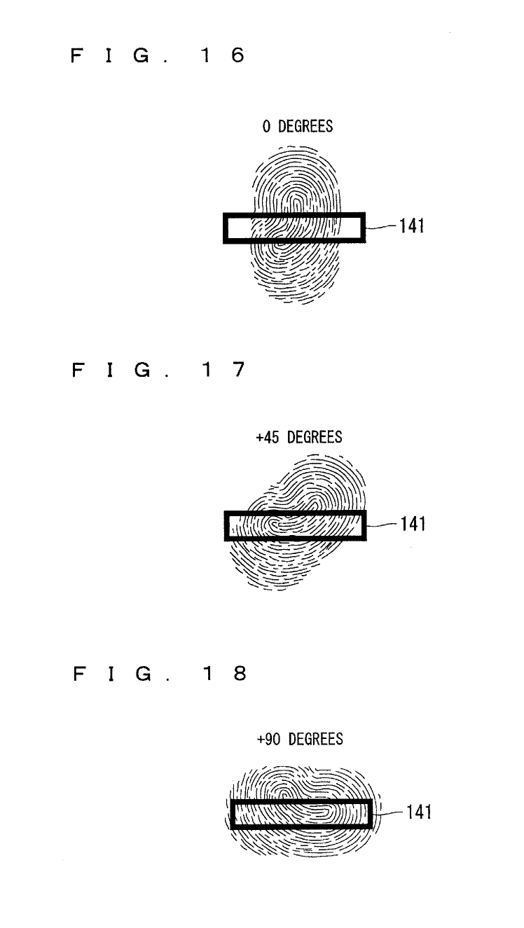

As illustrated in FIG. 13, the orientation of the finger 500 when the finger 500 at the 0-degree orientation is rotated 90 degrees in the clockwise direction in a case where the electronic apparatus 1 is viewed from the display area 20 side is defined as +90 degrees. In other words, when the finger 500 touching the operation area 30 points in a direction of 3 o'clock in a case where the electronic apparatus 1 in the portrait orientation with the receiver hole 22 located in the upper portion is viewed from the display area 20 side, the orientation of the finger 500 is defined as +90 degrees.

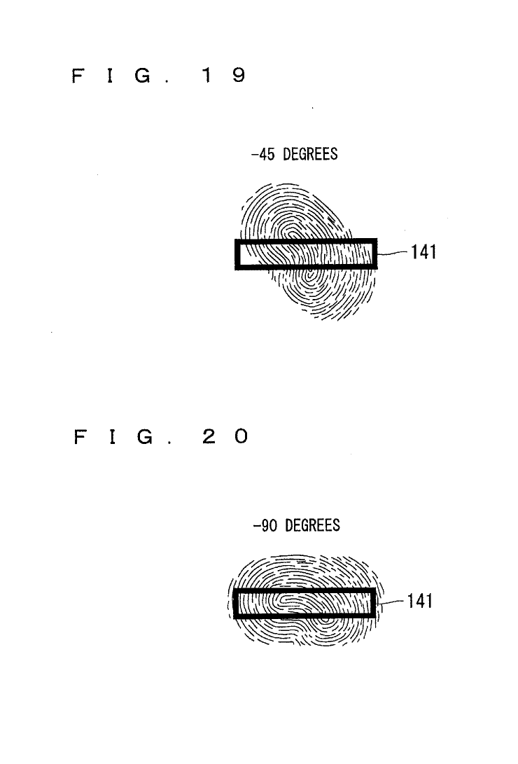

As illustrated in FIG. 14, the orientation of the finger 500 when the finger 500 at the 0-degree orientation is rotated 45 degrees in a counterclockwise direction in a case where the electronic apparatus 1 is viewed from the display area 20 side is defined as −45 degrees. In other words, when the finger 500 touching the operation area 30 points in a direction between 10 o'clock and 12 o'clock in a case where the electronic apparatus 1 in the portrait orientation with the receiver hole 22 located in the upper portion is viewed from the display area 20 side, the orientation of the finger 500 is defined as −45 degrees.

As illustrated in FIG. 15, the orientation of the finger 500 when the finger 500 at the 0-degree orientation is rotated 90 degrees in the counterclockwise direction in a case where the electronic apparatus 1 is viewed from the display area 20 side is defined as −90 degrees. In other words, when the finger 500 touching the operation area 30 points in a direction of 9 o'clock in a case where the electronic apparatus 1 in the portrait orientation with the receiver hole 22 located in the upper portion is viewed from the display area 20 side, the orientation of the finger 500 is defined as −90 degrees.

FIGS. 16, 17, 18, 19, and 20 schematically show examples of the fingerprint of the finger touching the operation area 30 when the orientations of the finger are 0 degrees, +45 degrees, +90 degrees, −45 degrees, and −90 degrees, respectively. The fingerprint shown in each of FIGS. 16 to 20 is a fingerprint of the same finger.

As shown in FIGS. 16 to 20, the fingerprint in the fingerprint detection range 141 varies depending on the orientation of the finger even when the fingerprint is the fingerprint of the same finger. Different feature points can thus be acquired from the fingerprint of the finger depending on the orientation of the finger even when the fingerprint is the fingerprint of the same finger. In the reference feature point table 400, the reference feature point representing the features of the detected fingerprint in each of the cases where the orientations of the finger 500 of the authorized user touching the operation area 30 are 0 degrees, +45 degrees, +90 degrees, −45 degrees, and −90 degrees is registered.

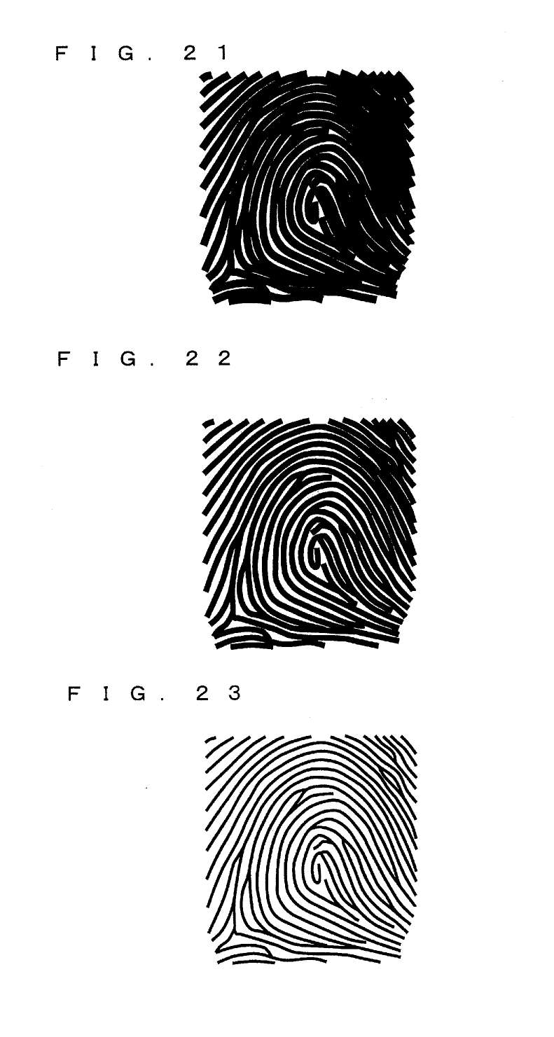

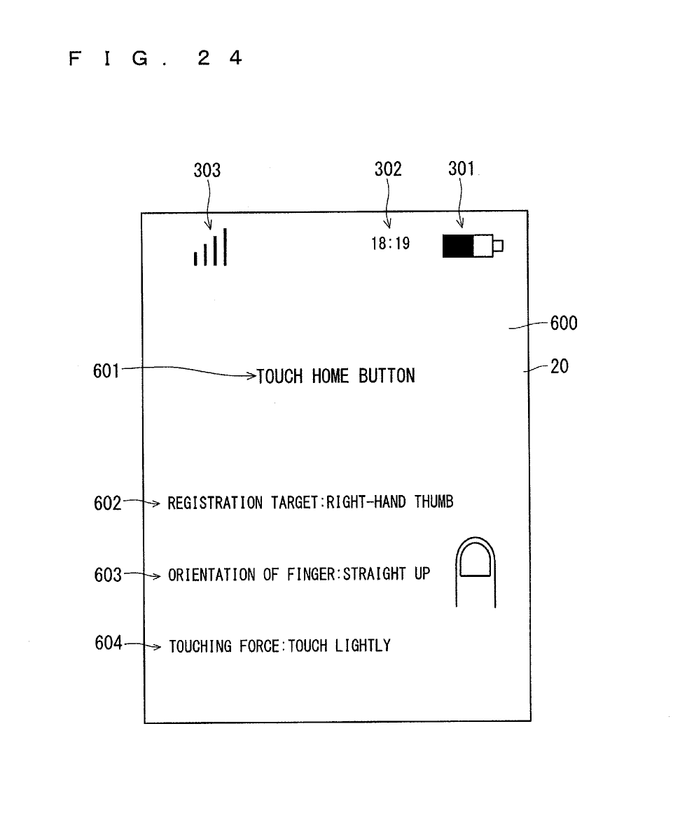

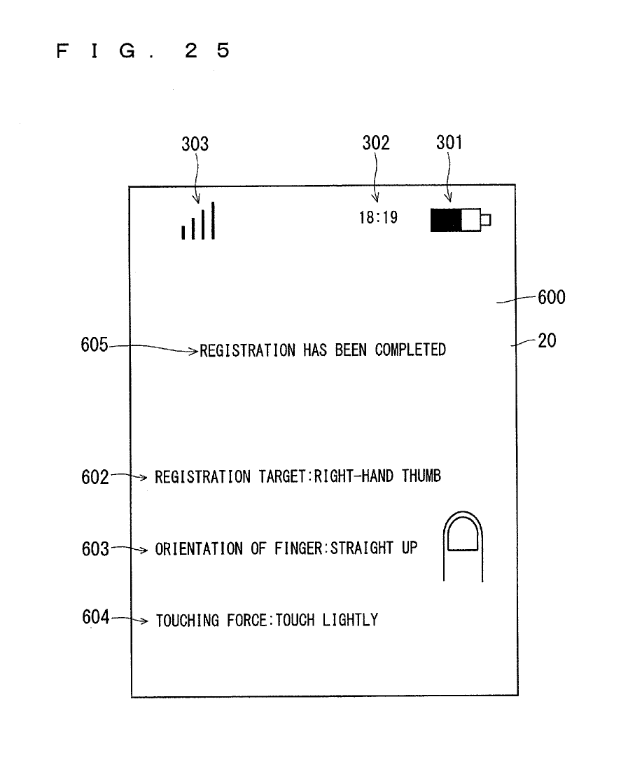

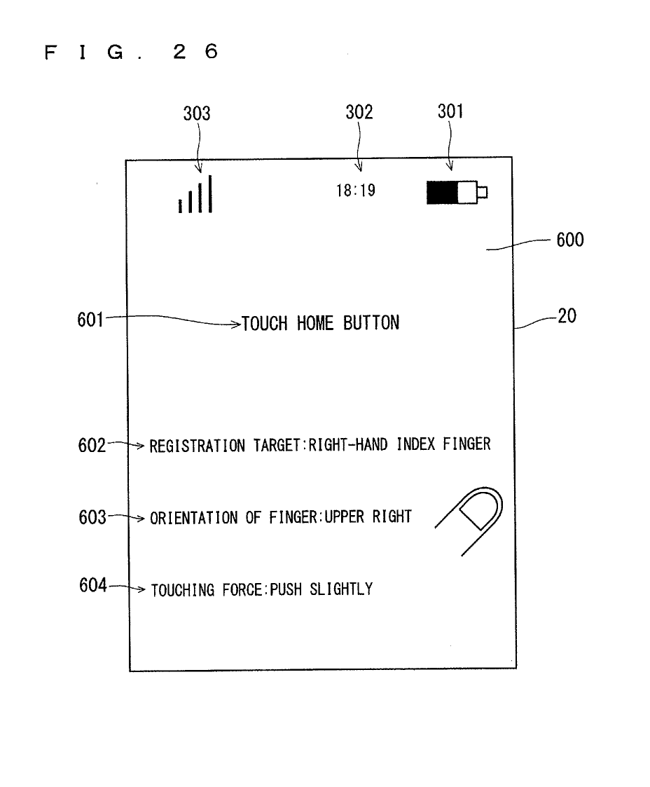

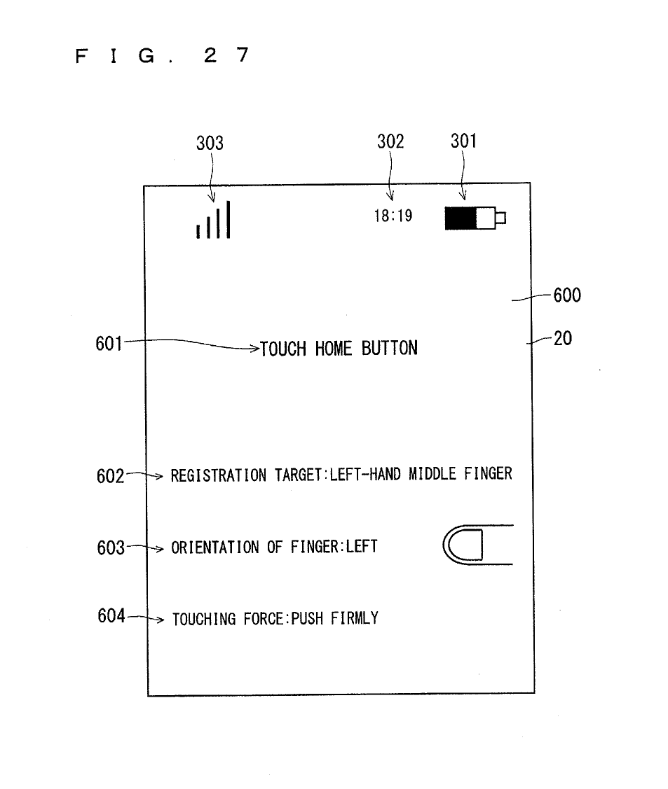

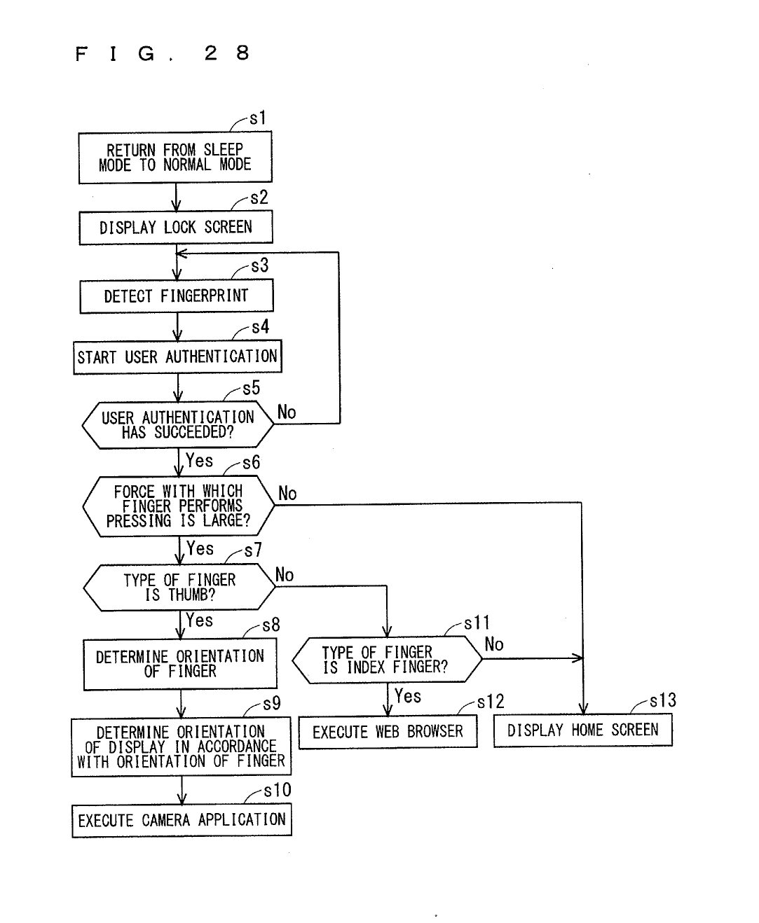

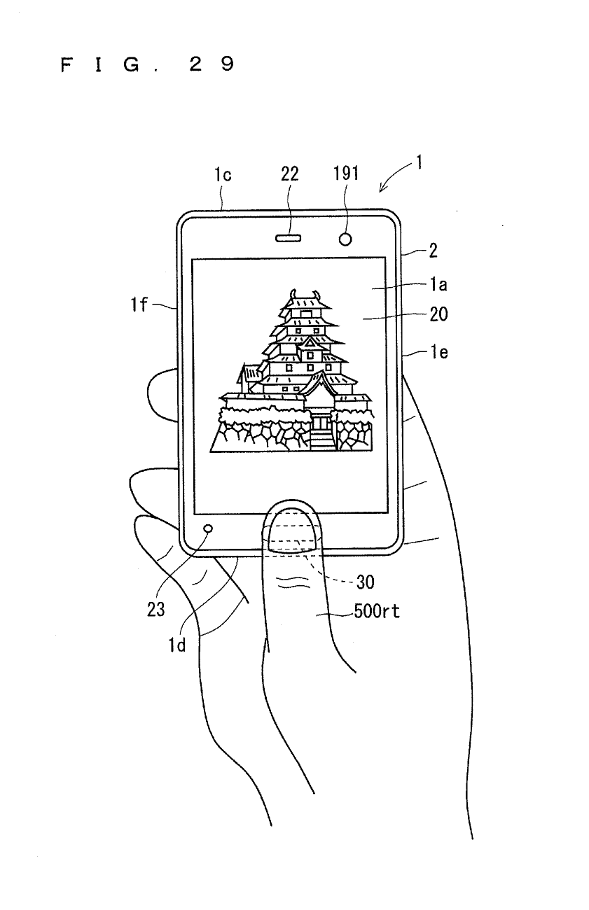

FIG. 21 schematically shows the fingerprint detected by the fingerprint sensor 140 when the force with which the finger presses against the operation area 30 is large. FIG. 22 schematically shows the fingerprint detected by the fingerprint sensor 140 when the force with which the finger presses against the operation area 30 is normal. FIG. 23 schematically shows the fingerprint detected by the fingerprint sensor 140 when the force with which the finger presses against the operation area 30 is small. FIGS. 21 to 23 each show the fingerprint of the same finger. In each of FIGS. 21 to 23, the size of the fingerprint detection range 141 of the fingerprint sensor 140 is imaginarily increased to facilitate understanding of the detected fingerprint.

As shown in FIGS. 21 to 23, the detected fingerprint varies depending on the force with which the finger presses against the operation area 30 even when the detected fingerprint is the fingerprint of the same finger. Specifically, the thickness of a ridge line of the fingerprint detected by the fingerprint sensor 140 increases with increasing force with which the finger presses against the operation area 30 as the fingerprint of the finger is squashed in the operation area 30. As a result, the locations of the end point and the branch point of the ridge line of the detected fingerprint change. Different feature points can thus be acquired from the fingerprint of the finger depending on the force with which the finger presses against the operation area 30 even when the fingerprint is the fingerprint of the same finger. In the reference feature point table 400, the reference feature point representing the features of the detected fingerprint in each of the cases where the forces with which the finger presses against the operation area 30 are “large”, “normal”, and “small” is registered.

In performing the user authentication based on the result of fingerprint detection by the fingerprint sensor 140, the controller 100 compares the feature point extracted from the result of fingerprint detection with each of the plurality of reference feature points registered in the plurality of reference feature point tables 400 stored in the storage 103.

<Method of Registering Reference Feature Points>

When a predetermined operation is performed on the display area 20 of the electronic apparatus 1 in the fingerprint registration mode, a fingerprint registration screen 600 is displayed in the display area 20. The authorized user can register, in the electronic apparatus 1, the reference feature point representing features of the fingerprint of his/her finger when the fingerprint registration screen 600 is displayed in the display area 20. The reference feature point is registered when the electronic apparatus 1 is in the portrait orientation as illustrated in FIG. 2.

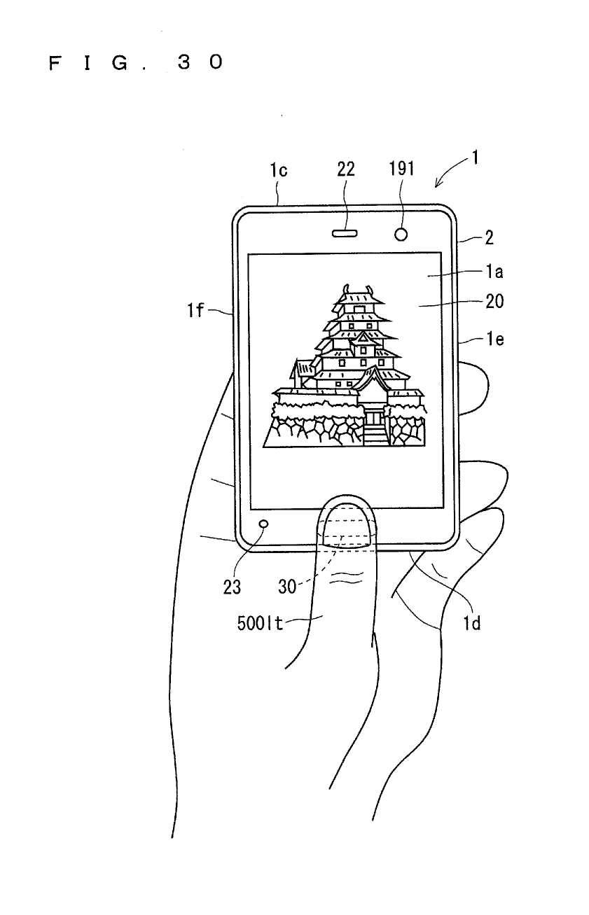

FIG. 24 illustrates an example of the fingerprint registration screen 600. As illustrated in FIG. 24, the fingerprint registration screen 600 includes operation instruction information 601 instructing the user to touch the operation area 30. The fingerprint registration screen 600 also includes type instruction information 602 indicating the type of the finger touching the operation area 30, orientation instruction information 603 indicating the orientation of the finger touching the operation area 30, and force instruction information 604 indicating the force with which the finger touches the operation area 30. The authorized user touches the operation area 30 with the finger in accordance with the type instruction information 602, the orientation instruction information 603, and the force instruction information 604, so that the reference feature point is registered in the reference feature point table 400 in accordance with the type instruction information 602, the orientation instruction information 603, and the force instruction information 604. In the example of FIG. 24, the reference feature point (corresponding to a reference feature point α33 in FIG. 9) representing the features of the detected fingerprint when the finger touching the operation area 30 is the right-hand thumb, the orientation of the finger is 0 degrees, and the force with which the finger presses against operation area 30 is small is registered in the reference feature point table 400 corresponding to the right-hand thumb. A term “straight up” included in the fingerprint registration screen 600 of FIG. 24 means the 0-degree orientation, and a term “touch lightly” included in the fingerprint registration screen 600 means that the force with which the finger presses against the operation area 30 is small.

When registration of one reference feature point is completed, a registration completion screen 610 is displayed in the display area 20. FIG. 25 illustrates an example of the registration completion screen 610 corresponding to the fingerprint registration screen 600 illustrated in FIG. 24. As illustrated in FIG. 25, the registration completion screen 610 includes completion notification information 605 notifying the user that fingerprint registration has been completed in addition to the type instruction information 602, the orientation instruction information 603, and the force instruction information 604.

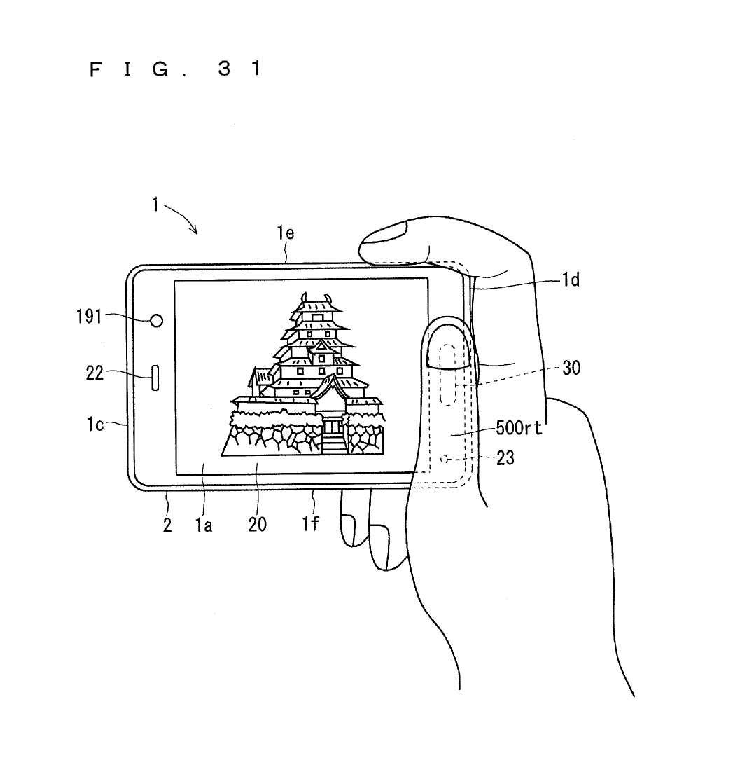

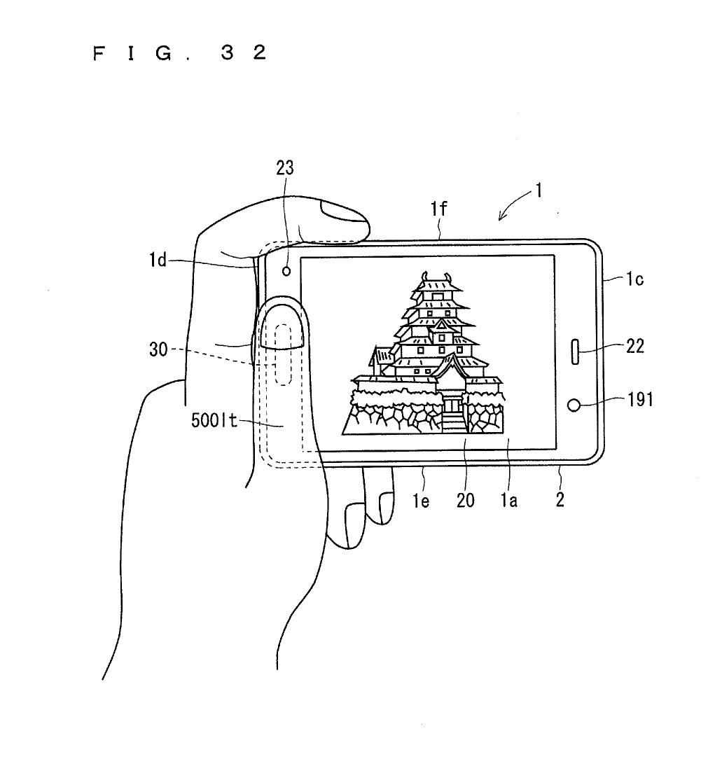

FIGS. 26 and 27 illustrate other examples of the fingerprint registration screen 600. A term “upper right” included in the fingerprint registration screen 600 of FIG. 26 means a +45-degree orientation, and a term “push slightly” included in the fingerprint registration screen 600 means that the force with which the finger presses against the operation area 30 is normal. A term “left” included in the fingerprint registration screen 600 of FIG. 27 means a −90-degree orientation, and a term “push firmly” included in the fingerprint registration screen 600 means that the force with which the finger presses against the operation area 30 is large. The term “push firmly” herein means, for example, pushing with a force not to turn on the push button 150.

The authorized user touches the operation area 30 with the finger in accordance with the type instruction information 602, the orientation instruction information 603, and the force instruction information 604 included in the fingerprint registration screen 600 of FIG. 26, so that the reference feature point representing the features of the detected fingerprint when the finger touching the operation area 30 is the right-hand index finger, the orientation of the finger is +45 degrees, and the force with which the finger presses against the operation area 30 is normal is registered in the reference feature point table 400 corresponding to the right-hand index finger.

The authorized user touches the operation area 30 with the finger in accordance with the type instruction information 602, the orientation instruction information 603, and the force instruction information 604 included in the fingerprint registration screen 600 of FIG. 27, so that the reference feature point representing the features of the detected fingerprint when the finger touching the operation area 30 is the left-hand middle finger, the orientation of the finger is −90 degrees, and the force with which the finger presses against the operation area 30 is large is registered in the reference feature point table 400 corresponding to the left-hand middle finger.

The user can change the fingerprint registration screen 600 displayed in the display area 20 by operating the display area 20. The user registers the plurality of reference feature points in the electronic apparatus 1 while changing the fingerprint registration screen 600 displayed in the display area 20.

<Determination of Force with Which Finger Performs Pressing>

The controller 100 can determine the force with which the finger presses against the operation area 30 based on a predetermined determination condition using the result of fingerprint detection by the fingerprint sensor 140. In determining the force with which the finger presses against the operation area 30, the controller 100 first extracts the feature point from the fingerprint image acquired by the fingerprint sensor 140. The controller 100 then specifies a reference feature point similar to the extracted feature point from the plurality of reference feature points stored in the storage 103. In the reference feature point table 400 in which the reference feature point similar to the extracted feature point is registered, the controller 100 specifies the force with which the finger performs pressing associated with the reference feature point. The controller 100 determines the specified force with which the finger performs pressing as the force with which the finger presses against the operation area 30. For example, when the force with which the finger performs pressing associated with the reference feature point is “large” in the reference feature point table 400 in which the reference feature point similar to the extracted feature point is registered, the controller 100 determines that the force with which the finger presses against the operation area 30 is large.

As described above, the controller 100 functions as a force determination unit that can determine the force with which the finger presses against the operation area 30. The “force with which the finger performs pressing” hereinafter means the force with which the finger presses against the operation area 30 unless otherwise noted.

<Determination of Orientation of Finger>

The controller 100 can determine the orientation of the finger touching the operation area 30 based on a predetermined determination condition using the result of fingerprint detection by the fingerprint sensor 140. In determining the orientation of the finger touching the operation area 30, the controller 100 first extracts the feature point from the fingerprint image acquired by the fingerprint sensor 140. The controller 100 then specifies a reference feature point similar to the extracted feature point from the plurality of reference feature points stored in the storage 103. In the reference feature point table 400 in which the reference feature point similar to the extracted feature point is registered, the controller 100 specifies the orientation of the finger associated with the reference feature point. The controller 100 determines the specified orientation of the finger as the orientation of the finger touching the operation area 30. For example, when the orientation of the finger associated with the reference feature point is “+90 degrees” in the reference feature point table 400 in which the reference feature point similar to the extracted feature point is registered, the controller 100 determines that the orientation of the finger touching the operation area 30 is +90 degrees.

As described above, the controller 100 functions as an orientation determination unit that can determine the orientation of the finger touching the operation area 30. The “orientation of the finger” hereinafter means the orientation of the finger touching the operation area 30 unless otherwise noted.

<Determination of Type of Finger>

The controller 100 can determine the type of the finger touching the operation area 30 based on a predetermined determination condition using the result of fingerprint detection by the fingerprint sensor 140. In determining the type of the finger touching the operation area 30, the controller 100 first extracts the feature point from the fingerprint image acquired by the fingerprint sensor 140. The controller 100 then specifies a reference feature point similar to the extracted feature point from the plurality of reference feature points stored in the storage 103. The controller 100 determines, as the type of the finger touching the operation area 30, the type of the finger corresponding to the reference feature point table 400 in which the reference feature point similar to the extracted feature point is registered. For example, when the reference feature point table 400 in which the reference feature point similar to the extracted feature point is registered corresponds to the right-hand thumb, the controller 100 determines that the type of the finger touching the operation area 30 is the right-hand thumb.

As described above, the controller 100 functions as a type determination unit that can determine the type of the finger touching the operation area 30, The “type of the finger” hereinafter means the type of the finger touching the operation area 30 unless otherwise noted.

<Processing in Accordance with Force with Which Finger Performs Pressing, Orientation of Finger, and Type of Finger>

The controller 100 can change processing to be performed in accordance with the force with which the finger performs pressing. The controller 100 can also change the processing to be performed in accordance with the orientation of the finger. The controller 100 can also change the processing to be performed in accordance with the type of the finger. Description will be made on this point below by taking, as an example, the operation of the electronic apparatus 1 when the electronic apparatus 1 returns from the sleep mode to the normal mode.

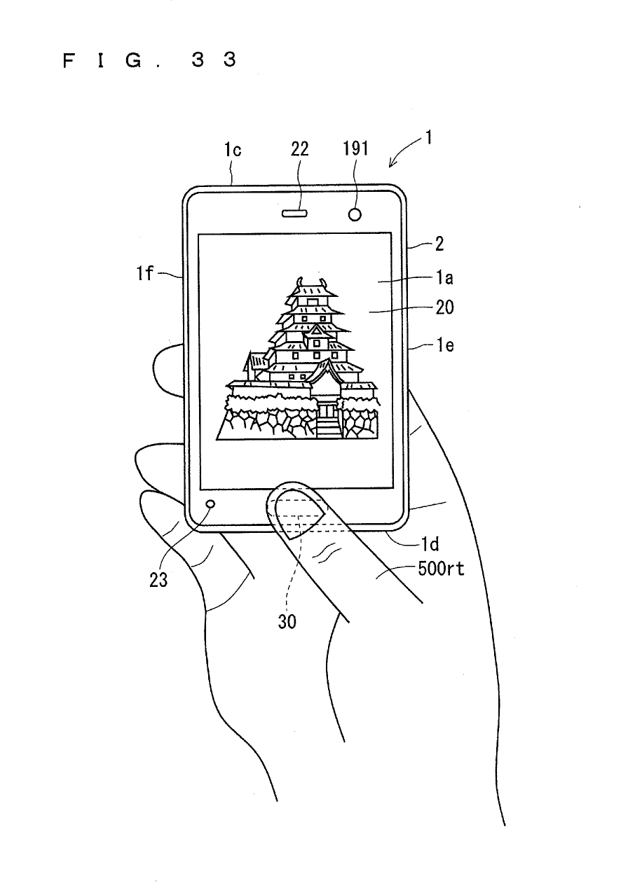

FIG. 28 illustrates a flowchart showing an example of the operation of the electronic apparatus 1 when the electronic apparatus 1 returns from the sleep mode to the normal mode. When the operation area 30 of the electronic apparatus 1 operating in the sleep mode is pushed to turn on the push button 150, the operation mode of the electronic apparatus 1 returns from the sleep mode to the normal mode in step s1. In step s2, the lock screen is displayed in the display area 20.

After step s2, the controller 100 operates the fingerprint sensor 140 whose operation has been stopped, and monitors a signal output from the fingerprint sensor 140. When the fingerprint sensor 140 detects the fingerprint of the finger of the user in step s3, the controller 100 starts the user authentication based on the result of fingerprint detection by the fingerprint sensor 140 in step s4. The controller 100 stops monitoring the signal output from the fingerprint sensor 140.

When the user authentication ends, the controller 100 determines whether the user authentication has succeeded in step s5. When determining that the user authentication has succeeded, the controller 100 performs step s6. On the other hand, when determining that the user authentication has failed, the controller 100 monitors the signal output from the fingerprint sensor 140 again. When the fingerprint sensor 140 then detects the fingerprint of the finger of the user in step s3, the electronic apparatus 1 hereinafter operates in a similar manner.

In step s6, the controller 100 determines whether the force with which the finger performs pressing is large based on the result of fingerprint detection obtained in step s3. In step s6, the controller 100 determines the force with which the finger performs pressing based on the predetermined determination condition using the result of fingerprint detection obtained in step s3 as described above. When determining that the force with which the finger performs pressing is large, the controller 100 performs step s7. On the other hand, when determining that the force with which the finger performs pressing is not large, that is, when determining that the force with which the finger performs pressing is normal or small, the controller 100 causes the display panel 120 to display the home screen in step s13. The display in the display area 20 thus transitions from the lock screen to the home screen.

As described above, the user can change the display of the electronic apparatus 1 from the lock screen to the home screen by lightly touching, with the finger, the operation area 30 of the electronic apparatus 1 displaying the lock screen or by slightly pushing the operation area 30 with the finger.

In step s7, the controller 100 determines whether the type of the finger is the thumb based on the result of fingerprint detection obtained in step s3. In step s7, the controller 100 determines the type of the finger based on the predetermined determination condition using the result of fingerprint detection obtained in step s3 as described above. When determining that the type of the finger is the thumb, the controller 100 performs step s8. That is to say, the controller 100 performs step s8 when determining that the type of the finger is the right-hand thumb or the left-hand thumb. On the other hand, when determining that the type of the finger is not the thumb, the controller 100 determines whether the type of the finger is the index finger in step s11.

When determining that the type of the finger is the index finger in step s11, the controller 100 executes the web browser stored in the storage 103 in step s12. That is to say, the controller 100 executes the web browser when determining that the type of the finger is the right-hand index finger or the left-hand index finger. During execution of the web browser, the controller 100 acquires a web page from the web server through the wireless communication unit 110, and causes the display panel 120 to display the acquired web page. The display in the display area 20 thus transitions from the lock screen to the web page.

On the other hand, when determining that the type of the finger is not the index finger in step s11, the controller 100 performs step s13 to cause the display panel 120 to display the home screen. The display in the display area 20 thus transitions from the lock screen to the home screen.

As described above, the user can cause the electronic apparatus 1 to execute the web browser, and change the display of the electronic apparatus 1 from the lock screen to the web page by firmly pushing, with the index finger, the operation area 30 of the electronic apparatus 1 displaying the lock screen. The user can also change the display of the electronic apparatus 1 from the lock screen to the home screen by firmly pushing, with the finger other than the thumb and the index finger, the operation area 30 of the electronic apparatus 1 displaying the lock screen.

When determining that the type of the finger is the thumb in step s7, the controller 100 determines the orientation of the finger based on the predetermined determination condition using the result of fingerprint detection obtained in step s3 as described above in step s8. The controller 100 then determines the orientation of the display in the display area 20 (a display of the display panel 120) in accordance with the orientation of the finger in step s9. Detailed description will be made on processing in step s9 below.

After step s9, the controller 100 executes the camera application stored in the storage 103 in step s10. When execution of the camera application is started, the controller 100 activates one of the front-side imaging unit 190 and the rear-side imaging unit 200. The controller 100 causes the display panel 120 to display an image captured by the activated imaging unit. In this case, the controller 100 controls the display panel 120 so that the orientation of the display in the display area 20 (the orientation of the display of the display panel 120) is set to the orientation determined in step s9. A shutter button is displayed in the display area 20 during execution of the camera application.

As described above, the user can cause the electronic apparatus 1 to execute the camera application, and change the display of the electronic apparatus 1 from the lock screen to the image captured by the imaging unit by firmly pushing, with the thumb, the operation area 30 of the electronic apparatus 1 displaying the lock screen.

<Details of Step s9>

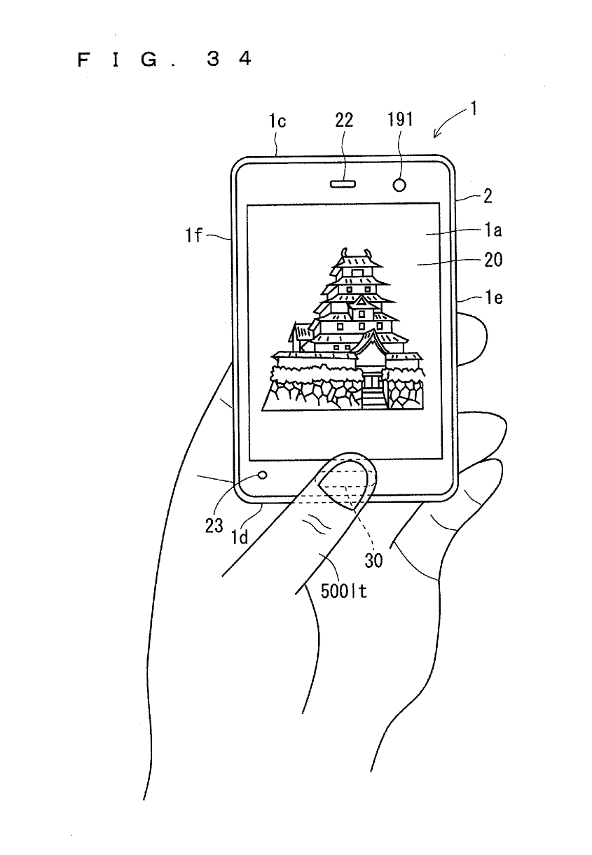

In step s9, when the orientation of the finger is 0 degrees, the controller 100 determines that the user uses the electronic apparatus 1 in the portrait orientation with the first side surface 1c located in the upper portion as illustrated in FIG. 10 described above. The controller 100 then determines, as the orientation of the display in the display area 20, the portrait orientation in accordance with the orientation of the electronic apparatus 1. That is to say, the controller 100 determines, as the orientation of the display in the display area 20, the orientation at which information, such as characters and figures, displayed in the display area 20 can be viewed in a right position (an original position) when the display area 20 of the electronic apparatus 1 in the portrait orientation with the first side surface 1c located in the upper portion is viewed. The orientation of the display in the display area 20 of the electronic apparatus 1 executing the camera application after step s10 is thus the orientation as illustrated in FIGS. 29 and 30. When the orientation of the finger is 0 degrees, the controller 100 determines, as the orientation of the display in the display area 20, the portrait orientation regardless of whether the type of the finger is the right-hand thumb or the left-hand thumb. FIG. 29 illustrates how the user touches, with a right-hand thumb 500rt, the operation area 30 of the electronic apparatus 1 in the portrait orientation. FIG. 30 illustrates how the user touches, with a left-hand thumb 500lt, the operation area 30 of the electronic apparatus 1 in the portrait orientation. The orientation of the right-hand thumb 500rt illustrated in FIG. 29 and the orientation of the left-hand thumb 500lt illustrated in FIG. 30 are each 0 degrees.

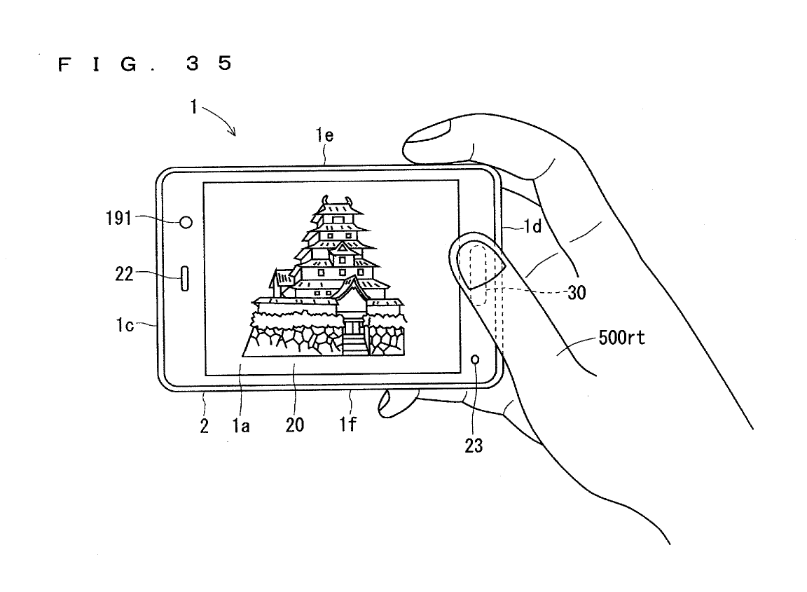

In step s9, when the type of the finger is the right-hand thumb, and the orientation of the finger is +90 degrees, the controller 100 determines that the user uses the electronic apparatus 1 in the landscape orientation with the third side surface 1e located in the upper portion. The controller 100 then determines, as the orientation of the display in the display area 20, a landscape orientation in accordance with the orientation of the electronic apparatus 1. That is to say, the controller 100 determines, as the orientation of the display in the display area 20, the orientation at which information, such as characters, figures, and images, displayed in the display area 20 can be viewed in the right position (the original position) when the display area 20 of the electronic apparatus 1 in the landscape orientation with the third side surface 1e located in the upper portion is viewed. The orientation of the display in the display area 20 of the electronic apparatus 1 executing the camera application after step s10 is thus the orientation as illustrated in FIG. 31. FIG. 31 illustrates how the user touches, with the right-hand thumb 500rt, the operation area 30 of the electronic apparatus 1 in the landscape orientation with the third side surface 1e located in the upper portion. The orientation of the right-hand thumb 500rt illustrated in FIG. 31 is +90 degrees.

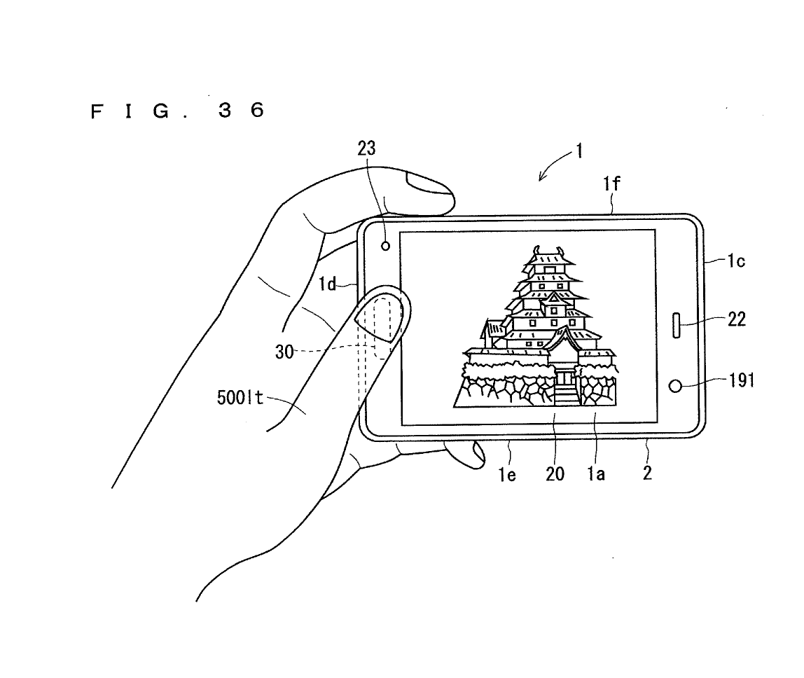

In step s9, when the type of the finger is the left-hand thumb, and the orientation of the finger is −90 degrees, the controller 100 determines that the user uses the electronic apparatus 1 in the landscape orientation with the fourth side surface 1f located in the upper portion. The controller 100 then determines, as the orientation of the display in the display area 20, the landscape orientation in accordance with the orientation of the electronic apparatus 1. That is to say, the controller 100 determines, as the orientation of the display in the display area 20, the orientation at which information, such as characters and figures, displayed in the display area 20 can be viewed in the right position (the original position) when the display area 20 of the electronic apparatus 1 in the landscape orientation with the fourth side surface 1f located in the upper portion is viewed. The orientation of the display in the display area 20 of the electronic apparatus 1 executing the camera application after step s10 is thus the orientation as illustrated in FIG. 32. FIG. 32 illustrates how the user touches, with the left-hand thumb 500lt, the operation area 30 of the electronic apparatus 1 in the landscape orientation with the fourth side surface 1f located in the upper portion. The orientation of the left-hand thumb 500lt illustrated in FIG. 32 is −90 degrees.

As described above, the controller 100 determines the display in the display area 20 in accordance with the orientation of the finger touching the fingerprint detection range 141 to enable the electronic apparatus 1 to change the orientation of the display in the display area 20 in accordance with the orientation of the electronic apparatus 1. The electronic apparatus 1 can thus provide an easy-to-view display to the user automatically.

As described above, in the example of FIG. 28, the controller 100 executes the application, such as the web browser, when the force with which the finger performs pressing is large, and causes the display panel 120 to display the home screen when the force with which the finger performs pressing is not large.

In the example of FIG. 28, the controller 100 executes the camera application when the type of the finger is the thumb, executes the web browser when the type of the finger is the index finger, and causes the display panel 120 to display the home screen when the type of the finger is the finger other than the thumb and the index finger.

In the example of FIG. 28, the controller 100 sets the orientation of the display in the display area 20 to the portrait orientation when the orientation of the finger is 0 degrees, and sets the orientation of the display in the display area 20 to the landscape orientation when the orientation of the finger is +90 degrees or −90 degrees.

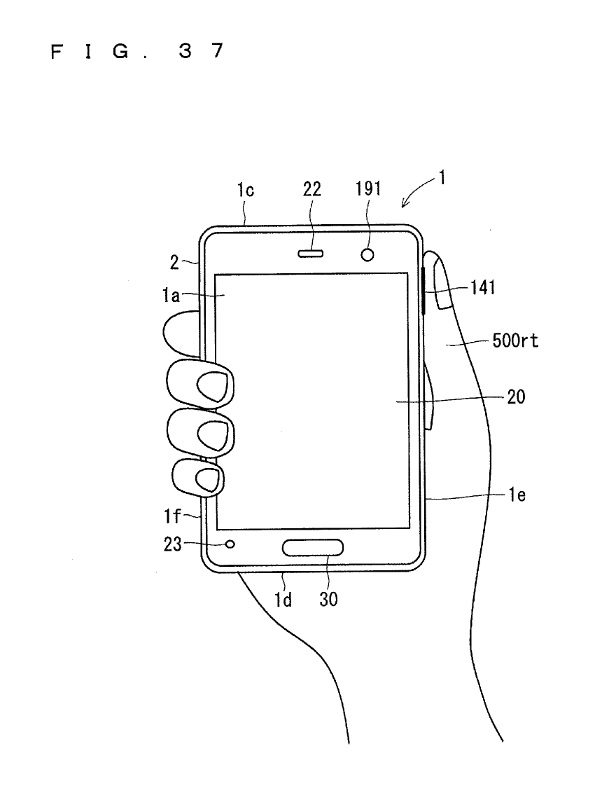

When the user touches the operation area 30 of the electronic apparatus 1 in the portrait orientation with the right-hand thumb, the orientation of the right-hand thumb 500rt can become −45 degrees as illustrated in FIG. 33. Thus, in step s9, the portrait orientation may be determined as the orientation of the display in the display area 20 when the type of the finger is the right-hand thumb, and the orientation of the finger is −45 degrees.

When the user touches the operation area 30 of the electronic apparatus 1 in the portrait orientation with the left-hand thumb, the orientation of the left-hand thumb 500lt can become +45 degrees as illustrated in FIG. 34. Thus, in step s9, the portrait orientation may be determined as the orientation of the display in the display area 20 when the type of the finger is the left-hand thumb, and the orientation of the finger is +45 degrees.

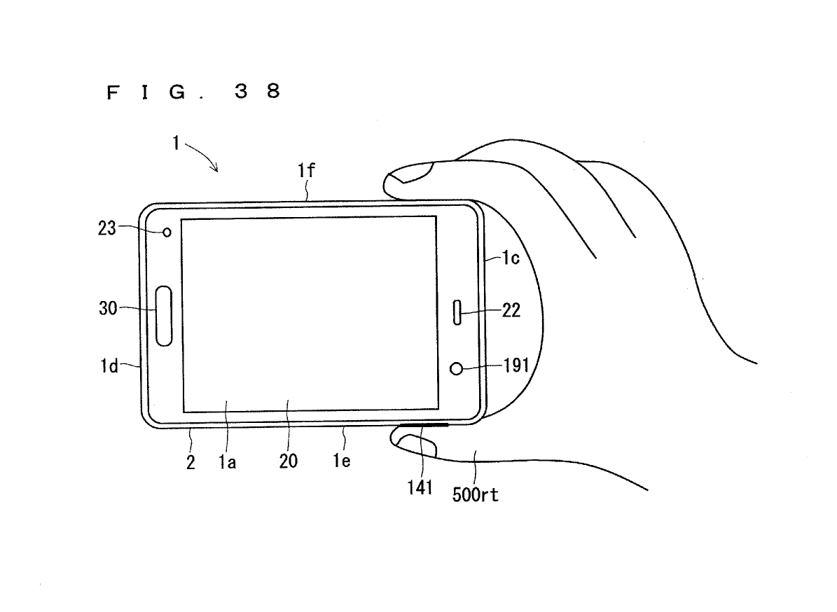

When the user touches the operation area 30 of the electronic apparatus 1 in the landscape orientation with the right-hand thumb, the orientation of the right-hand thumb 500rt can become +45 degrees as illustrated in FIG. 35. Thus, in step s9, the landscape orientation may be determined as the orientation of the display in the display area 20 when the type of the finger is the right-hand thumb, and the orientation of the finger is +45 degrees.

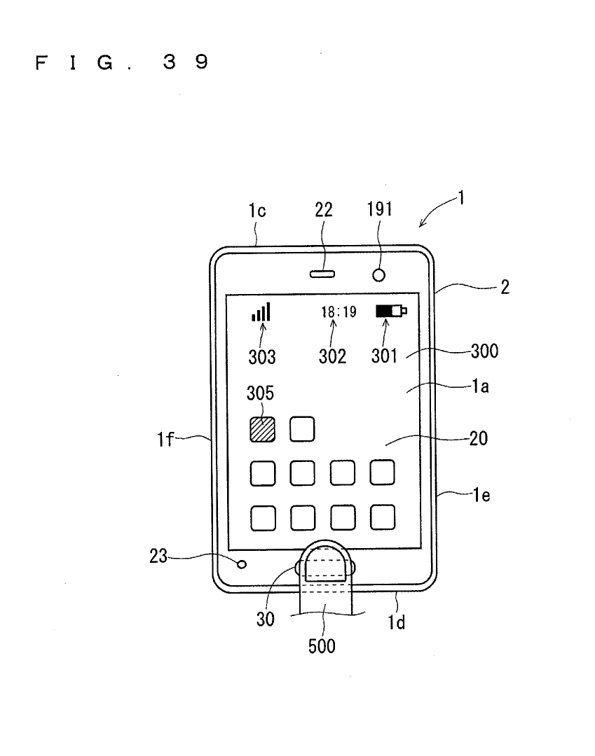

When the user touches the operation area 30 of the electronic apparatus 1 in the landscape orientation with the left-hand thumb, the orientation of the left-hand thumb 500lt can become −45 degrees as illustrated in FIG. 36. Thus, in step s9, the landscape orientation may be determined as the orientation of the display in the display area 20 when the type of the finger is the left-hand thumb, and the orientation of the finger is −45 degrees.

In the example of FIG. 28, processing similar to processing in steps s8 and s9 may be performed between steps s11 and s12 to determine the orientation of the display in the display area 20 in accordance with the orientation of the finger. In this case, the orientation of the web page displayed in the display area 20 of the electronic apparatus 1 executing the web browser in step s12 is the orientation determined between steps s11 and s12.

In the example of FIG. 28, the processing similar to the processing in steps s8 and s9 may be performed immediately before step s13 to determine the orientation of the display in the display area 20 in accordance with the orientation of the finger. In this case, the orientation of the home screen displayed in step s13 is the orientation determined immediately before step s13.

In the example of FIG. 28, an application other than the camera application may be executed when it is determined that the type of the finger is the thumb in step s7. For example, the e-mail application, the music playback control application, or an application designated by the user may be executed. Alternatively, the web browser may be executed. In this case, the web browser is executed when the type of the finger is the thumb and when the type of the finger is the index finger.

In the example of FIG. 28, an application other than the web browser may be executed when it is determined that the type of the finger is the index finger in step s11. For example, the e-mail application, the music playback control application, or the application designated by the user may be executed. Alternatively, the camera application may be executed. In this case, the camera application is executed when the type of the finger is the thumb and when the type of the finger is the index finger.

In the example of FIG. 28, it is determined whether the type of the finger is the thumb in step s7, but it may be determined whether the type of the finger is a finger other than the thumb. For example, it may be determined whether the type of the finger is the middle finger in step s7. It is also determined whether the type of the finger is the index finger in step s11, but it may be determined whether the type of the finger is a finger other than the index finger. For example, it may be determined whether the type of the finger is a little finger in step s11.

In the above-mentioned example, the reference feature points for each right-hand finger of the authorized user and the reference feature points for each left-hand finger of the authorized user are registered in the electronic apparatus 1, but the authorized user may register, in the electronic apparatus 1, the reference feature points for only one of each right-hand finger and each left-hand finger. For example, the authorized user may register, in the electronic apparatus 1, the reference feature points for only each dominant-hand finger.

In the above-mentioned example, the reference feature points for each of the ten fingers of the authorized user are registered in the electronic apparatus 1, but the authorized user may register, in the electronic apparatus 1, the reference feature points for one or more of the ten fingers.

The controller 100 determines the type of the finger, but the controller 100 may not determine the type of the finger. In this case, step s8 is performed when an affirmative determination is made in step s6, and steps s7, s11, and s12 are not performed in the example of FIG. 28.

The controller 100 may not determine the orientation of the finger. In this case, step s10 is performed when an affirmative determination is made in step s7, and steps s8 and s9 are not performed in the example of FIG. 28.

The controller 100 may not determine the force with which the finger performs pressing. In this case, step s7 is performed when an affirmative determination is made in step s5, and step s6 is not performed in the example of FIG. 28.

The controller 100 may not determine the type of the finger and the orientation of the finger. In this case, step s10 is performed when the affirmative determination is made in step s6, and steps s7 to s9, s11, and s12 are not performed in the example of FIG. 28.

The controller 100 may not determine the type of the finger and the force with which the finger performs pressing. In this case, step s8 is performed when the affirmative determination is made in step s5, and steps s6, s7, and s11 to s13 are not performed in the example of FIG. 28. In this case, the home screen may be displayed instead of executing the camera application in step s10.

The controller 100 may not determine the orientation of the finger and the force with which the finger performs pressing. In this case, step s7 is performed when the affirmative determination is made in step s5, step s10 is performed when the affirmative determination is made in step s7, and steps s6, s8, and s9 are not performed in the example of FIG. 28.

As described above, in the electronic apparatus 1, the controller 100 changes the processing to be performed in accordance with the force with which the finger presses against the fingerprint detection range 141 of the fingerprint sensor 140. The user can thus cause the electronic apparatus 1 to perform different types of processing by changing the force with which the finger pushes (touches) the fingerprint detection range 141 of the fingerprint sensor 140. The user can cause the electronic apparatus 1 to perform desired processing by performing a simple operation on the electronic apparatus 1. As a result, the operability of the electronic apparatus 1 improves.

The controller 100 also changes the processing to be performed in accordance with the orientation of the finger touching the fingerprint detection range 141 of the fingerprint sensor 140 relative to the electronic apparatus 1. The user can thus cause the electronic apparatus 1 to perform different types of processing by changing the orientation of the finger touching the fingerprint detection range 141 of the fingerprint sensor 140. The user can cause the electronic apparatus 1 to perform the desired processing by performing the simple operation on the electronic apparatus 1. As a result, the operability of the electronic apparatus 1 improves.

The controller 100 also changes the processing to be performed in accordance with the type of the finger touching the fingerprint detection range 141 of the fingerprint sensor 140. The user can thus cause the electronic apparatus 1 to perform different types of processing by changing the type of the finger touching the fingerprint detection range 141 of the fingerprint sensor 140. The user can cause the electronic apparatus 1 to perform the desired processing by performing the simple operation on the electronic apparatus 1. As a result, the operability of the electronic apparatus 1 improves.

In the above-mentioned example, the controller 100 determines the force with which the finger performs pressing by comparing the feature point acquired from the fingerprint detected by the fingerprint sensor 140 with the plurality of reference feature points corresponding to the force with which the finger performs pressing, but the force with which the finger performs pressing may be determined based on the thickness of the ridge line of the fingerprint detected by the fingerprint sensor 140. For example, the thickness of the ridge line of the fingerprint of the finger when the force with which the finger performs pressing is normal is registered in the storage 103 as a reference thickness. The controller 100 compares the thickness of the ridge line of the fingerprint detected by the fingerprint sensor 140 with the reference thickness registered in the storage 103, and determines the force with which the finger performs pressing based on a result of comparison. For example, the controller 100 determines that the force with which the finger performs pressing is normal when the absolute value of the difference between the thickness of the ridge line of the fingerprint detected by the fingerprint sensor 140 and the reference thickness is equal to or smaller than a threshold. The controller 100 determines that the force with which the finger performs pressing is large when a value obtained by subtracting the reference thickness from the thickness of the ridge line of the fingerprint detected by the fingerprint sensor 140 is a positive value, and the absolute value of the obtained value is greater than the threshold. The controller 100 determines that the force with which the finger performs pressing is small when the value obtained by subtracting the reference thickness from the thickness of the ridge line of the fingerprint detected by the fingerprint sensor 140 is a negative value, and the absolute value of the obtained value is greater than the threshold.

In the example of FIG. 28 described above, the controller 100 may cause the display panel 120 to display the home screen when the orientation of the finger is 0 degrees, and execute the camera application when the orientation of the finger is +90 degrees or −90 degrees without determining the force with which the finger performs pressing and the type of the finger. When the orientation of the finger is +90 degrees or −90 degrees, the electronic apparatus 1 is likely to be used in the landscape orientation as illustrated in FIGS. 31 and 32. When the electronic apparatus 1 is used in the landscape orientation, the user may wish to use a camera function of the electronic apparatus 1. The camera application is executed when the orientation of the finger is +90 degrees or −90 degrees to enable the user who uses the electronic apparatus 1 in the landscape orientation to use the camera function of the electronic apparatus 1 immediately. The operability of the electronic apparatus 1 thus improves.

<Various Modifications>

Various modifications will be described below.

<Modification of Location of Fingerprint Detection Range of Fingerprint Detection Sensor>

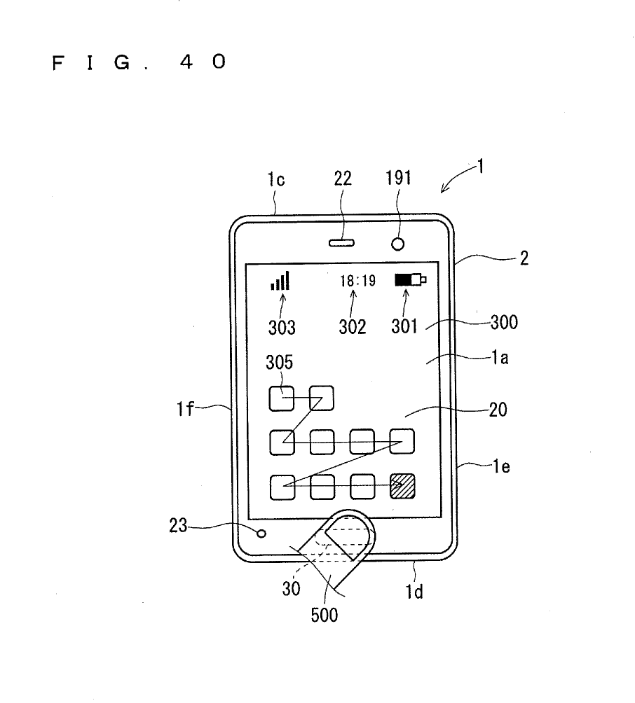

Although the fingerprint detection range 141 of the fingerprint sensor 140 is included in the operation area 30 of the push button 150 in the above-mentioned example, the fingerprint detection range 141 may not be included in the operation area 30. This means that the fingerprint detection range 141 may be provided at a location different from the location of the operation area 30. For example, the fingerprint detection range 141 may be located on a side surface of the electronic apparatus 1. FIG. 37 illustrates a front view showing an example of the appearance of the electronic apparatus 1 in which the fingerprint detection range 141 is located on the side surface thereof. In the electronic apparatus 1 illustrated in FIG. 37, the fingerprint detection range 141 is located on the third side surface 1e. Specifically, the fingerprint detection range 141 is located on a portion of the third side surface 1e a little closer to the first side surface 1c than to the middle portion in the longitudinal direction. FIG. 37 illustrates how the user touches the fingerprint detection range 141 with the right-hand thumb 500rt.

In the electronic apparatus 1 illustrated in FIG. 37, the reference feature point when the orientation of the fingerprint is +180 degrees is registered in the reference feature point table 400 corresponding to the right-hand thumb. In the electronic apparatus 1 illustrated in FIG. 37, when the finger 500 touching the operation area 30 points in the direction along the longitudinal direction of the display area 20 and toward the first side surface 1c in a case where the electronic apparatus 1 is viewed from the third side surface 1e side, the orientation of the finger 500 is defined as 0 degrees. The orientation of the right-hand thumb 500rt in FIG. 37 is thus 0 degrees. The orientation of the finger 500 when the finger 500 at the 0-degree orientation is rotated 45 degrees in the clockwise direction in a case where the electronic apparatus 1 is viewed from the third side surface 1e side is defined as +45 degrees. The orientation of the finger 500 when the finger 500 at the 0-degree orientation is rotated 90 degrees in the clockwise direction in a case where the electronic apparatus 1 is viewed from the third side surface 1e side is defined as +90 degrees. The orientation of the finger 500 when the finger 500 at the 0-degree orientation is rotated 45 degrees in the counterclockwise direction in a case where the electronic apparatus 1 is viewed from the third side surface 1e side is defined as −45 degrees. The orientation of the finger 500 when the finger 500 at the 0-degree orientation is rotated 90 degrees in the counterclockwise direction in a case where the electronic apparatus 1 is viewed from the third side surface 1e side is defined as −90 degrees. The orientation of the finger when the finger at the 0-degree orientation is rotated 180 degrees in the clockwise direction in a case where the electronic apparatus 1 is viewed from the third side surface 1e side is defined as +180 degrees. In the reference feature point table 400 corresponding to the right-hand thumb, the reference feature point when the orientation of the fingerprint is +180 degrees is registered for each of a case where the force with which the finger performs pressing is large, a case where the force with which the finger performs pressing is normal, and a case where the force with which the finger performs pressing is small. The user can register, in the electronic apparatus 1, the reference feature point corresponding to the orientation of the fingerprint in a manner similar to the above-mentioned manner.

In the example of FIG. 28 described above, in step s9 described above, when the type of the finger is the right-hand thumb, and the orientation of the finger is 0 degrees, the controller 100 of the electronic apparatus 1 determines that the user uses the electronic apparatus 1 in the portrait orientation with the first side surface 1c located in the upper portion as illustrated in FIG. 37. The controller 100 then determines, as the orientation of the display in the display area 20, the portrait orientation in accordance with the orientation of the electronic apparatus 1. That is to say, the controller 100 determines, as the orientation of the display in the display area 20, the orientation at which information, such as characters and figures, displayed in the display area 20 can be viewed in the right position (the original position) when the display area 20 of the electronic apparatus 1 in the portrait orientation with the first side surface 1c located in the upper portion is viewed. The orientation of the display in the display area 20 of the electronic apparatus 1 executing the camera application after step s10 is thus similar to the orientation illustrated in FIG. 29 and the like described above.

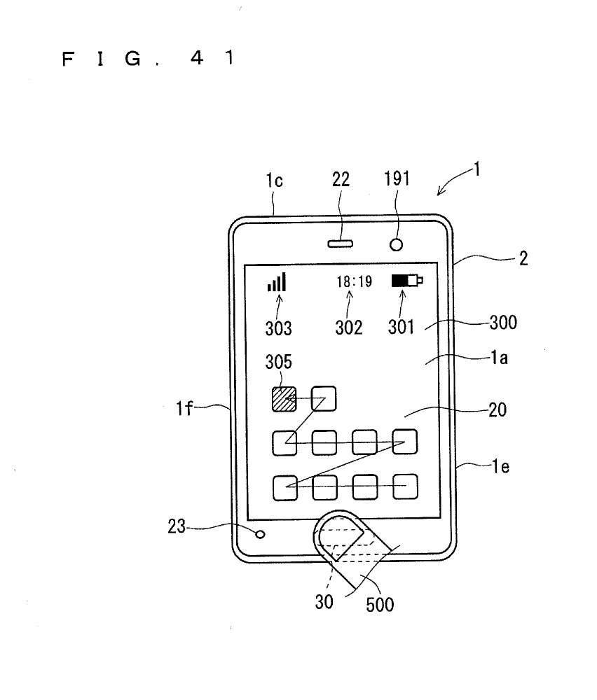

On the other hand, when the type of the finger is the right-hand thumb, and the orientation of the finger is +180 degrees, the controller 100 determines that the user uses the electronic apparatus 1 in the landscape orientation with the fourth side surface 1f located in the upper portion as illustrated in FIG. 38. The controller 100 then determines, as the orientation of the display in the display area 20, the landscape orientation in accordance with the orientation of the electronic apparatus 1. That is to say, the controller 100 determines, as the orientation of the display in the display area 20, the orientation at which information, such as characters and figures, displayed in the display area 20 can be viewed in the right position (the original position) when the display area 20 of the electronic apparatus 1 in the landscape orientation with the fourth side surface 1f located in the upper portion is viewed. The orientation of the display in the display area 20 of the electronic apparatus 1 executing the camera application after step s10 is thus similar to the orientation illustrated in FIG. 32 and the like described above.

<Selection of Icon>

The controller 100 may change an icon selected from a plurality of application icons displayed in the display area 20 in accordance with the orientation of the finger. An example of the operation of the electronic apparatus 1 in this case will be described below.

Upon detection of a change from a state in which the user does not touch the operation area 30 with the finger to a state in which the user touches the operation area 30 with the finger based on the result of fingerprint detection by the fingerprint sensor 140 in a case where the home screen 300 is displayed in the display area 20, the controller 100 selects one of the plurality of application icons 305 included in the home screen 300. For example, the controller 100 selects, from the plurality of application icons 305 included in the home screen 300, a leftmost application icon 305 in the top row as illustrated in FIG. 39. The selected application icon 305 is displayed in a different manner from the other application icons having not been selected. In FIG. 39, the selected application icon 305 is shaded. The same applies to the subsequent drawings.

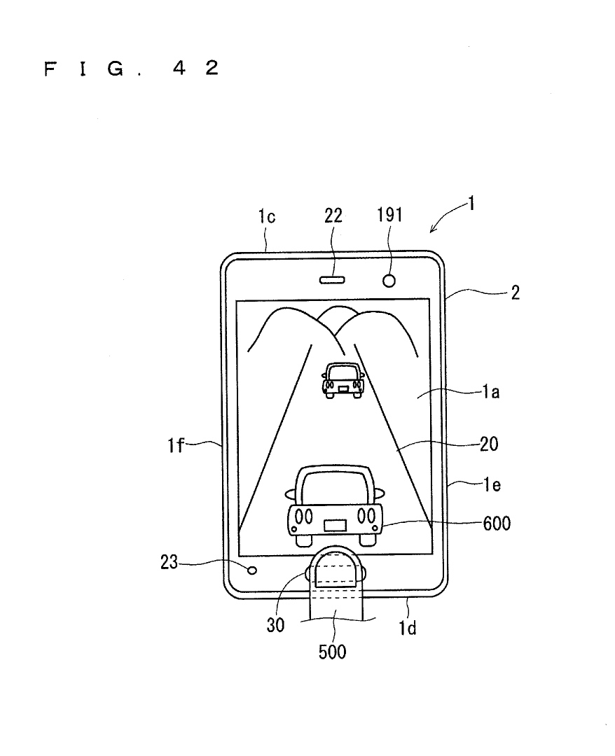

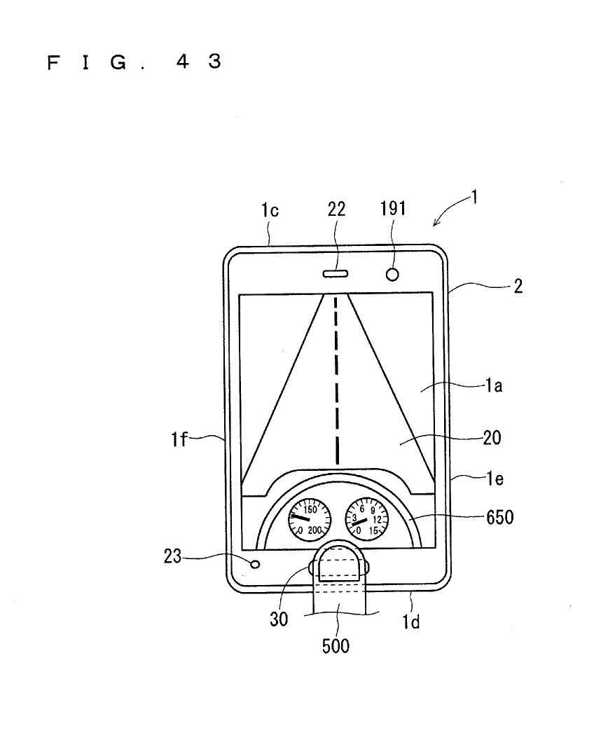

In the state in which the user touches the operation area 30 with the finger, the controller 100 repeatedly determines the orientation of the finger based on the result of fingerprint detection by the fingerprint sensor 140. When the orientation of the finger is +45 degrees, the controller 100 changes the selected application icon 305 in turn. For example, the controller 100 selects the plurality of application icons 305 in turn along a raster direction as illustrated in FIG. 40. By maintaining the orientation of the finger touching the operation area 30 at +45 degrees, the user can change the application icon 305 selected by the electronic apparatus 1 one after another along the raster direction. On the other hand, when the orientation of the finger is −45 degrees, the controller 100 selects the plurality of application icons 305 in turn along a direction opposite the raster direction as illustrated in FIG. 41, for example. By maintaining the orientation of the finger touching the operation area 30 at −45 degrees, the user can change the application icon 305 selected by the electronic apparatus 1 one after another along the direction opposite the raster direction. Upon detection of a change from the state in which the user touches the operation area 30 with the finger to the state in which the user does not touch the operation area 30 with the finger, the controller 100 executes an application corresponding to the application icon 305 selected at the time. The user can cause the electronic apparatus 1 to execute a desired application by releasing the finger from the operation area 30.

The controller 100 may shift the selected application icon 305 by one along the raster direction each time the orientation of the finger changes from 0 degrees to +45 degrees. By slightly rotating the finger touching the operation area 30 in the clockwise direction from the 0-degree orientation, the user can shift the application icon 305 selected by the electronic apparatus 1 by one along the raster direction.

The controller 100 may shift the selected application icon 305 by one along the direction opposite the raster direction each time the orientation of the finger changes from 0 degrees to −45 degrees. By slightly rotating the finger touching the operation area 30 in the counterclockwise direction from the 0-degree orientation, the user can shift the application icon 305 selected by the electronic apparatus 1 by one along the direction opposite the raster direction.

As described above, in the present modification, the controller 100 changes the icon selected from the plurality of application icons 305 displayed in the display area 20 in accordance with the orientation of the finger, and thus the user can cause the electronic apparatus 1 to select the desired application icon 305 by changing the orientation of the finger. The controller 100 may select an icon other than the application icon in a similar manner. The controller 100 may also select an object other than the icon displayed in the display area 20 in a similar manner.

<Control of Speed of Object to be Operated in Game>

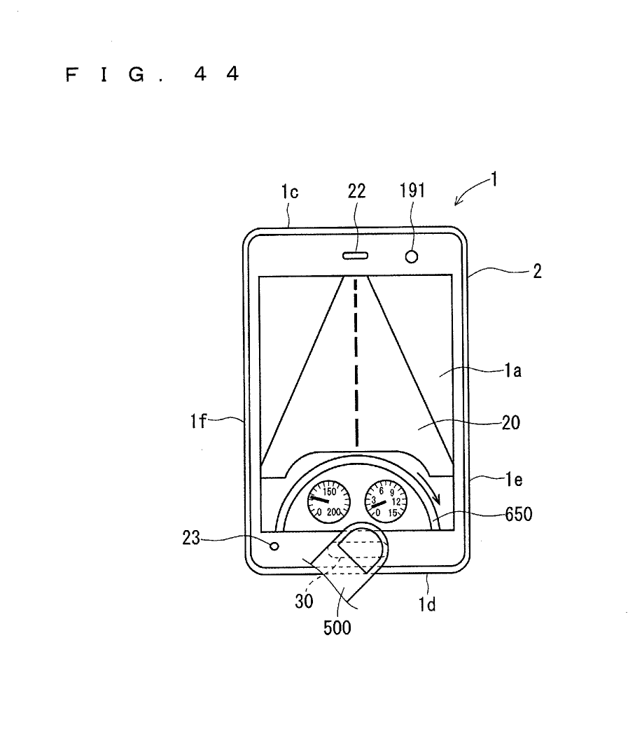

When the game application is being executed, the controller 100 may change the speed of an object to be operated in a game in accordance with the force with which the finger performs pressing. For example, as illustrated in FIG. 42, the controller 100 may increase the speed of a car 600 to be operated by the user with increasing force with which the finger 500 performs pressing in a racing game. The user can change the speed of the car 600 by changing the extent to which the finger 500 pushes the operation area 30, and thus the fingerprint detection range 141 of the fingerprint sensor 140 functions as an accelerator of the car.

The controller 100 may also increase a moving speed of a character, such as a person, to be operated by the user with increasing force with which the finger performs pressing in an action game and the like.

As described above, the controller 100 changes the speed of the object to be operated in the game in accordance with the force with which the finger performs pressing to enable the user to change the speed of the object to be operated in the game by changing the extent to which the finger pushes the operation area 30.

<Control of Orientation of Object to be Operated in Game>

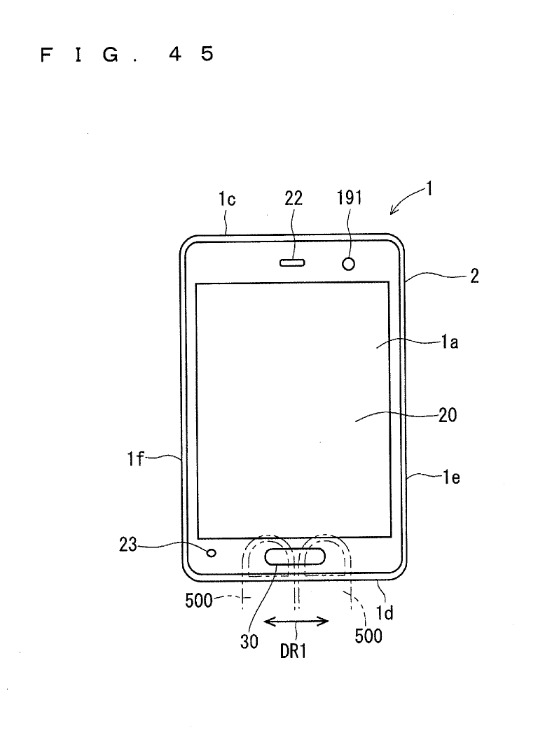

When the game application is being executed, the controller 100 may change the orientation of the object to be operated in the game in accordance with the orientation of the finger. For example, the controller 100 may change the orientation of a steering wheel of the car to be operated by the user in accordance with the orientation of the finger in the racing game. Specifically, in a case where an application of the racing game is being executed in the electronic apparatus 1 in the portrait orientation with the first side surface 1c located in the upper portion, the controller 100 causes a steering wheel 650 to be turned neither in the clockwise direction nor in the counterclockwise direction when the orientation of the finger 500 is 0 degrees as illustrated in FIG. 43. The controller 100 causes the steering wheel 650 to be turned 45 degrees in the clockwise direction when the orientation of the finger 500 is +45 degrees as illustrated in FIG. 44, and causes the steering wheel 650 to be turned 90 degrees in the clockwise direction when the orientation of the finger 500 is +90 degrees. On the other hand, the controller 100 causes the steering wheel 650 to be turned 45 degrees in the counterclockwise direction when the orientation of the finger 500 is −45 degrees, and causes the steering wheel 650 to be turned 90 degrees in the counterclockwise direction when the orientation of the finger 500 is −90 degrees. The user can thus operate the steering wheel 650 of the car in the game by changing the orientation of the finger 500. In other words, the user can change a traveling direction of the car in the game by changing the orientation of the finger 500.

The controller 100 may also change the traveling direction of the character, such as a person, to be operated by the user in accordance with the orientation of the finger in the action game and the like. For example, in a case where an application of the action game or the like is being executed in the electronic apparatus 1 in the portrait orientation with the first side surface 1c located in the upper portion, the controller 100 causes the character to be operated to travel straight when the orientation of the finger is 0 degrees. The controller 100 turns the traveling direction of the character 45 degrees to the right when the orientation of the finger changes from 0 degrees to +45 degrees. The controller 100 turns the traveling direction of the character 90 degrees to the right when the orientation of the finger changes from 0 degrees to +90 degrees. The controller 100 turns the traveling direction of the character 45 degrees to the left when the orientation of the finger changes from 0 degrees to −45 degrees. The controller 100 turns the traveling direction of the character 90 degrees to the left when the orientation of the finger changes from 0 degrees to −90 degrees. The user can thus change the traveling direction of the character (the orientation of the moving character) in the game by changing the orientation of the finger.

As described above, the controller 100 changes the orientation of the object to be operated in the game in accordance with the orientation of the finger to enable the user to change the orientation of the object to be operated in the game by changing the orientation of the finger touching the operation area 30.

<Detection of Movement of Finger>

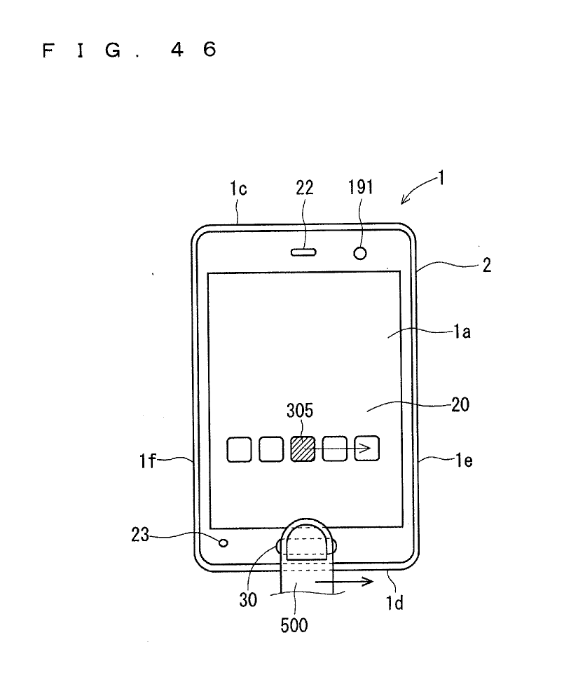

The controller 100 may detect movement of the finger based on the result of fingerprint detection by the fingerprint sensor 140. The controller 100 may change the processing to be performed in accordance with the detected movement of the finger. The fingerprint within the fingerprint detection range 141 detected by the fingerprint sensor 140 varies depending on the location of the finger on the fingerprint detection range 141. The controller 100 can thus detect movement of the finger on the fingerprint detection range 141 by continuously monitoring the result of fingerprint detection by the fingerprint sensor 140. The controller 100 herein detects movement of the finger 500 on the fingerprint detection range 141 along a transverse direction DR1 of the electronic apparatus 1, for example, as illustrated in FIG. 45. The controller 100 can detect a movement direction and a movement amount of the finger 500.

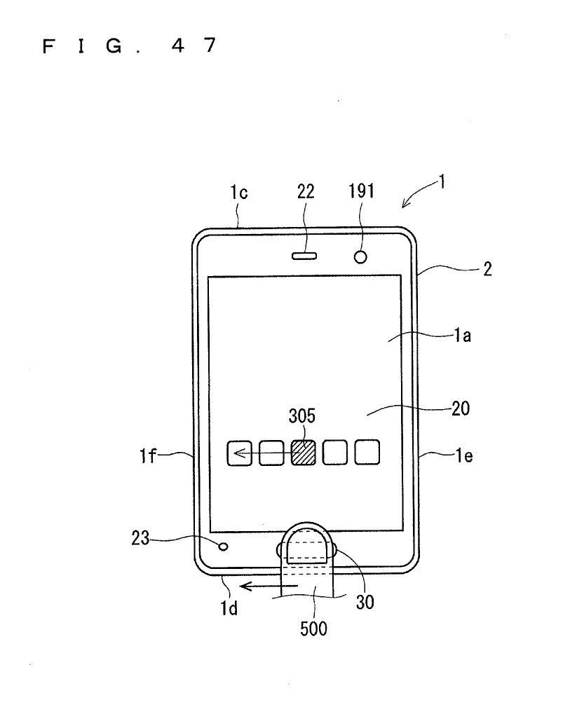

For example, the controller 100 changes the icon selected from the plurality of application icons displayed in the display area 20 in accordance with the detected movement of the finger. As illustrated in FIG. 46, when the plurality of application icons 305 are displayed, in the display area 20 of the electronic apparatus 1 in the portrait orientation with the first side surface 1c located in the upper portion, to be aligned along the transverse direction of the electronic apparatus 1, the controller 100 selects one of the displayed plurality of application icons 305 upon detection of the change from the state in which the user does not touch the operation area 30 with the finger to the state in which the user touches the operation area 30 with the finger. For example, the controller 100 selects a middle application icon 305 from the displayed plurality of application icons 305 as illustrated in FIG. 46.

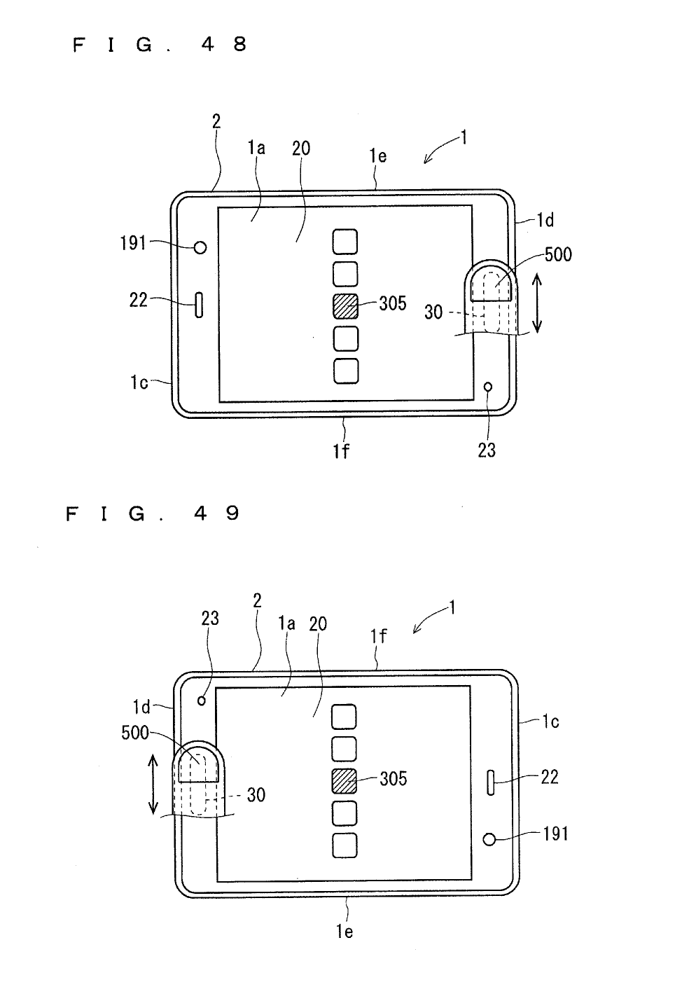

In the state in which the user touches the operation area 30 with the finger, the controller 100 detects the movement of the finger based on the result of fingerprint detection by the fingerprint sensor 140. When the controller 100 detects movement of the finger touching the operation area 30 toward the third side surface 1e as illustrated in FIG. 46, the controller 100 selects an application icon 305 located closer to the third side surface 1e than the currently selected application icon 305 is. In this case, the controller 100 selects an application icon 305 located farther from the currently selected application icon 305 as the finger moves greatly. For example, the controller 100 selects an application icon 305 next to the currently selected application icon 305 when the movement amount of the finger is equal to or smaller than a first threshold, and selects the second application icon 305 from the currently selected application icon 305 when the movement amount of the finger is greater than the first threshold and is equal to or smaller than a second threshold (greater than the first threshold). On the other hand, when the controller 100 detects movement of the finger touching the operation area 30 toward the fourth side surface 1f as illustrated in FIG. 47, the controller 100 selects an application icon 305 located closer to the fourth side surface 1f than the currently selected application icon 305 is. In this case, the controller 100 selects an application icon 305 located farther from the currently selected application icon 305 as the finger moves greatly. Upon detection of the change from the state in which the user touches the operation area 30 with the finger to the state in which the user does not touch the operation area 30 with the finger, the controller 100 executes the application corresponding to the application icon 305 selected at the time.

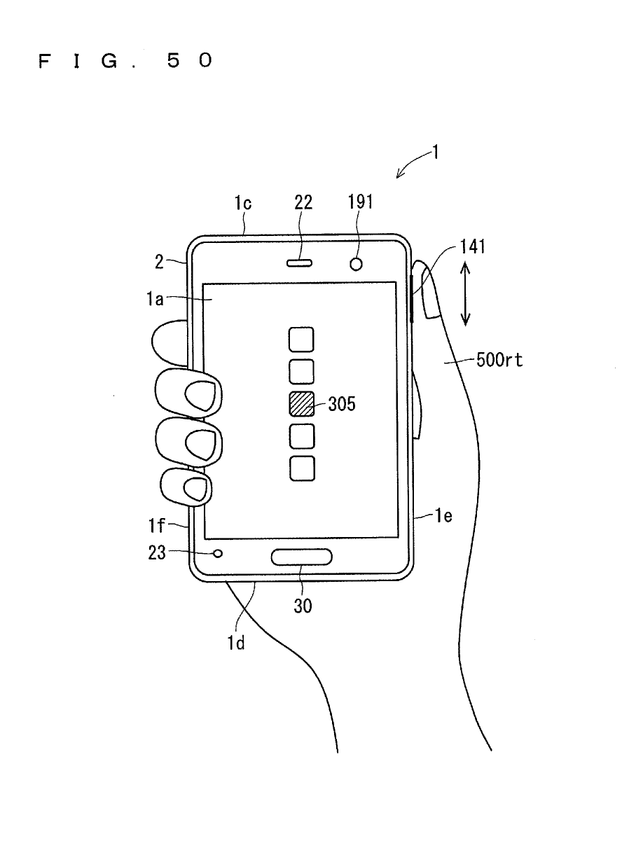

Even in a case where the electronic apparatus 1 is used in the landscape orientation, the controller 100 can change the icon selected from the plurality of application icons displayed in the display area 20 in accordance with the detected movement of the finger in a similar manner. For example, as illustrated in FIG. 48, when the plurality of application icons 305 are displayed, in the display area 20 of the electronic apparatus 1 in the landscape orientation with the third side surface 1e located in the upper portion, to be aligned along the transverse direction of the electronic apparatus 1, the controller 100 selects one of the displayed plurality of application icons 305 upon detection of the change from the state in which the user does not touch the operation area 30 with the finger to the state in which the user touches the operation area 30 with the finger. When the controller 100 detects the movement of the finger touching the operation area 30 toward the third side surface 1e, the controller 100 selects the application icon 305 located closer to the third side surface 1e than the currently selected application icon 305 is. On the other hand, when the controller 100 detects the movement of the finger touching the operation area 30 toward the fourth side surface 1f, the controller 100 selects the application icon 305 located closer to the fourth side surface 1f than the currently selected application icon 305 is.

As illustrated in FIG. 49, when the plurality of application icons 305 are displayed, in the display area 20 of the electronic apparatus 1 in the landscape orientation with the fourth side surface 1f located in the upper portion, to be aligned along the transverse direction of the electronic apparatus 1, the controller 100 selects one of the displayed plurality of application icons 305 upon detection of the change from the state in which the user does not touch the operation area 30 with the finger to the state in which the user touches the operation area 30 with the finger. When the controller 100 detects the movement of the finger touching the operation area 30 toward the third side surface 1e, the controller 100 selects the application icon 305 located closer to the third side surface 1e than the currently selected application icon 305 is. On the other hand, when the controller 100 detects the movement of the finger touching the operation area 30 toward the fourth side surface 1f, the controller 100 selects the application icon 305 located closer to the fourth side surface 1f than the currently selected application icon 305 is.

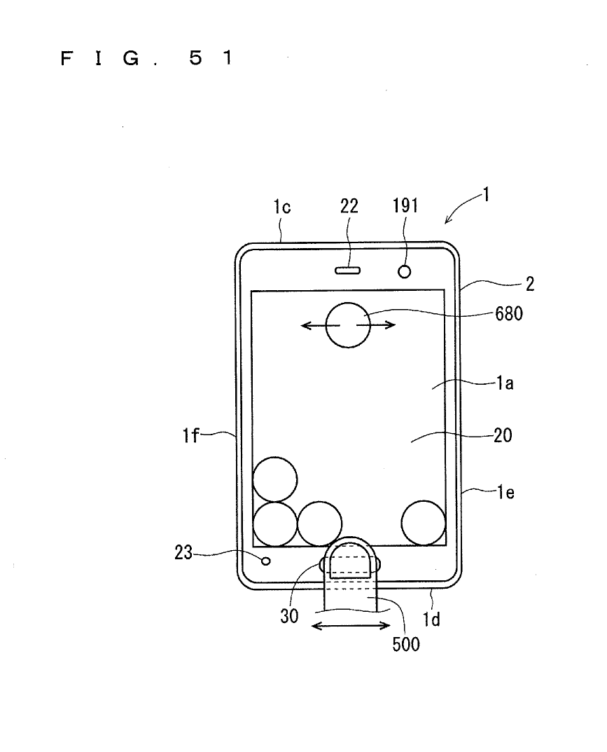

As illustrated in FIGS. 37 and 38 described above, even when the fingerprint detection range 141 is located on the third side surface 1e of the electronic apparatus 1, the controller 100 can change the icon selected from the plurality of application icons displayed in the display area 20 in accordance with the detected movement of the finger in a similar manner. For example, as illustrated in FIG. 50, when the plurality of application icons 305 are displayed, in the display area 20 of the electronic apparatus 1 in the portrait orientation with the first side surface 1c located in the upper portion, to be aligned along the longitudinal direction of the electronic apparatus 1, the controller 100 selects one of the displayed plurality of application icons 305 upon detection of the change from the state in which the user does not touch the operation area 30 with the finger to the state in which the user touches the operation area 30 with the finger. When the controller 100 detects movement of the finger touching the operation area 30 toward the first side surface 1c, the controller 100 selects an application icon 305 located closer to the first side surface 1c than the currently selected application icon 305 is. On the other hand, when the controller 100 detects movement of the finger touching the operation area 30 toward the second side surface 1d, the controller 100 selects an application icon 305 located closer to the second side surface 1d than the currently selected application icon 305 is. Even in a case where the electronic apparatus 1 in which the fingerprint detection range 141 is located on the side surface thereof is used in the landscape orientation, the controller 100 can change the icon selected from the plurality of application icons displayed in the display area 20 in accordance with the detected movement of the finger in a similar manner.

As described above, the controller 100 changes the application icon 305 selected from the plurality of application icons 305 in accordance with the detected movement of the finger to enable the user to change the application icon 305 selected by the electronic apparatus 1 by moving the finger on the fingerprint detection range 141. The operability of the electronic apparatus 1 thus improves. The controller 100 may select an icon other than the application icon in a similar manner. The controller 100 may also select an object other than the icon displayed in the display area 20 in a similar manner.

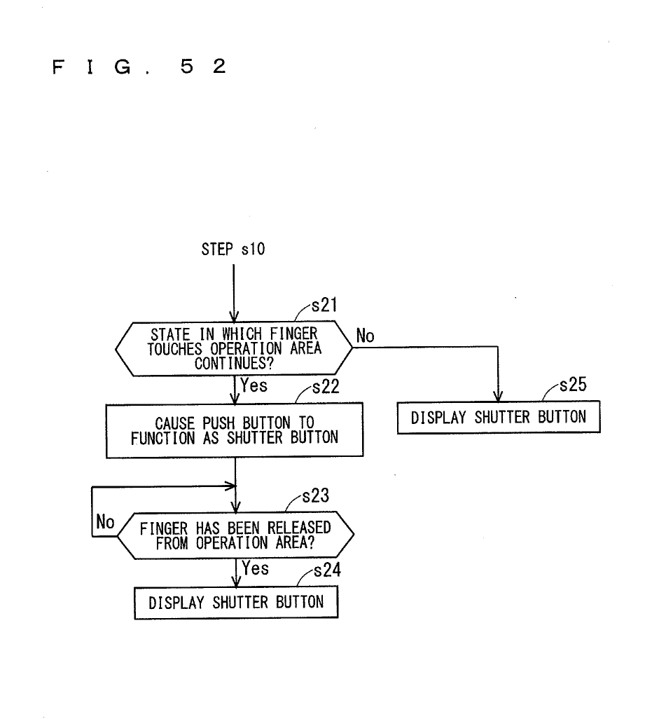

When the game application is being executed, the controller 100 may move the object to be operated in the game in accordance with the detected movement of the finger. For example, as illustrated in FIG. 51, the controller 100 may change the location, in the horizontal direction, of a falling object 680 to be operated by the user in accordance with the movement of the finger 500 in a puzzle game of stacking falling objects 680. For example, in a case where an application of the puzzle game is being executed in the electronic apparatus 1 in the portrait orientation with the first side surface 1c located in the upper portion, the controller 100 moves the falling object 680 toward the third side surface 1e when the finger 500 moves toward the third side surface 1e (to the right), and moves the falling object 680 toward the fourth side surface 1f when the finger 500 moves toward the fourth side surface 1f (to the left). The user can thus change the location, in the horizontal direction, of the falling object 680 in the puzzle game by changing the movement direction of the finger 500.

The controller 100 may switch a page displayed in the display area 20 or scroll the display in the display area 20 in accordance with the detected movement of the finger. For example, in a case where an e-book application for displaying e-books is being executed in the electronic apparatus 1 in the portrait orientation with the first side surface 1c located in the upper portion, the controller 100 changes the page displayed in the display area 20 to the next page when the finger moves toward the third side surface 1e (to the right), and changes the page displayed in the display area 20 to the previous page when the finger moves toward the fourth side surface 1f (to the left). In a case where the fingerprint detection range 141 is located on the third side surface 1e of the electronic apparatus 1 as illustrated in FIG. 37 described above, the controller 100 scrolls down the web page displayed in the display area 20 when the finger moves toward the first side surface 1c (upward), and scrolls up the web page displayed in the display area 20 when the finger moves toward the second side surface 1d (downward) during execution of the web browser.

As described above, the controller 100 changes the processing to be performed in accordance with the detected movement of the finger to enable the user to cause the electronic apparatus 1 to perform the desired processing by moving the finger on the fingerprint detection range 141. The operability of the electronic apparatus 1 thus improves.

<Use of Push Button as Shutter Button>

The controller 100 may cause the push button 150 to function as the shutter button (a release button) during execution of the camera application. The present modification will be described below.

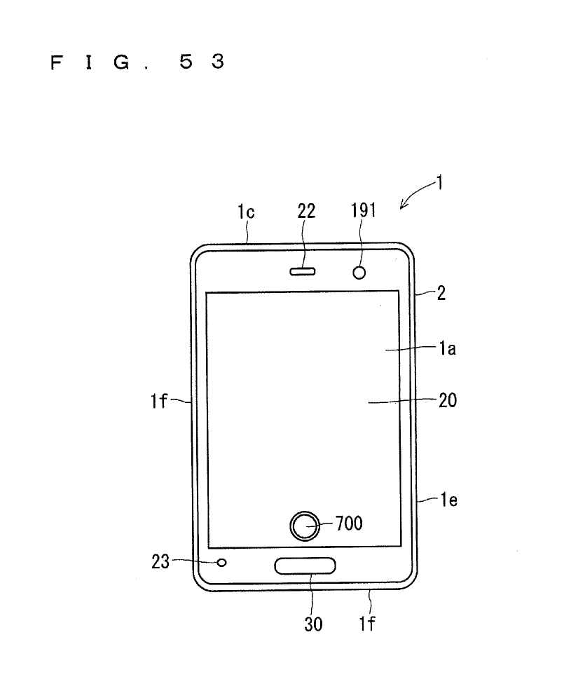

FIG. 52 illustrates a flowchart showing the operation of the electronic apparatus 1 according to the present modification. FIG. 52 shows processing subsequent to step s10 of FIG. 28 described above.

When execution of the camera application is started in step s10, the controller 100 determines whether the state in which the user touches the operation area 30 with the finger continues from the start of the user authentication in step s4 based on the result of fingerprint detection by the fingerprint sensor 140 in step s21. When determining that the state in which the user touches the operation area 30 with the finger continues from the start of the user authentication, the controller 100 causes the push button 150 to function as the shutter button in step s22. While the controller 100 causes the push button 150 to function as the shutter button, the controller 100 causes the display panel 120 not to display the shutter button. When the push button 150 changes from the off state to the on state while the push button 150 functions as the shutter button, an image captured by the front-side imaging unit 190 or the rear-side imaging unit 200 at the time is displayed as a still image in the display area 20. The user can store the still image displayed in the display area 20 in nonvolatile memory, such as flash memory, of the storage 103 by operating the display area 20. On the other hand, the controller 100 causes the display panel 120 to display the shutter button when determining that the finger of the user has been released from the operation area 30 after the start of the user authentication. In this case, the push button 150 does not function as the shutter button. FIG. 53 illustrates a display example of the shutter button. In the example of FIG. 53, a circular shutter button 700 is displayed in the display area 20. When the tap operation is performed on the shutter button 700, for example, an image captured by the front-side imaging unit 190 or the rear-side imaging unit 200 at the time is displayed as a still image in the display area 20.

After step s22, the controller 100 determines whether the finger has been released from the operation area 30 based on the result of fingerprint detection by the fingerprint sensor 140 in step s23. Step s23 is performed repeatedly until the controller 100 determines that the finger has been released from the operation area 30. The controller 100 causes the display panel 120 to display the shutter button 700 without causing the push button 150 to function as the shutter button when determining that the finger has been released from the operation area 30.

After the affirmative determination is made in step s5 of FIG. 28, steps s7 to s10 may be performed without performing step s6, and then step s21 and subsequent steps may be performed. That is to say, when the user authentication succeeds, execution of the camera application may be started without determining the force with which the finger performs pressing, and then processing in and after step s21 may be performed.

After the affirmative determination is made in step s5 of FIG. 28, steps s8 to s10 may be performed without performing steps s6 and s7, and then step s21 and subsequent steps may be performed. That is to say, when the user authentication succeeds, execution of the camera application may be started without determining the force with which the finger performs pressing and the type of the finger, and then the processing in and after step s21 may be performed.

After the affirmative determination is made in step s5 of FIG. 28, step s10 may be performed without performing steps s6 to s9, and then step s21 and subsequent steps may be performed. That is to say, when the user authentication succeeds, execution of the camera application may be started without determining the force with which the finger performs pressing, the type of the finger, and the orientation of the finger, and then the processing in and after step s21 may be performed.

As described above, in the present modification, the controller 100 causes the push button 150 to function as the shutter button during execution of the camera application when the state in which the user touches the operation area 30 with the finger continues from the start of the user authentication. While the user touches the operation area 30 with the finger, the user authentication is performed and the camera application is executed in the electronic apparatus 1, and the push button 150 functions as the shutter button. The user can thus operate the shutter button by holding down the finger touching the operation area 30 from the start of the user authentication so that the push button 150 changes from the off state to the on state. The operability of the electronic apparatus 1 thus improves.

The display in the display area 20 can effectively be used as the shutter button is not displayed in the display area 20 while the push button 150 functions as the shutter button.

Although the controller 100 determines the type of the finger and the like based on the result of fingerprint detection by the fingerprint sensor 140 in the above-mentioned various examples, the controller 100 may determine the type of the finger and the like based on biometric information other than the fingerprint acquired from the user. For example, the electronic apparatus 1 may include a detection sensor that detects a vein pattern of the finger, and the type of the finger and the like may be determined based on a result of detection by the detection sensor.

The electronic apparatus 1 may be an apparatus other than a mobile phone, such as a smartphone. For example, the electronic apparatus 1 may be a tablet terminal or a personal computer.

While the electronic apparatus 1 has been described in detail above, the foregoing description is in all aspects illustrative and does not restrict the present disclosure. Various modifications described above are applicable in combination unless any contradiction occurs. It is understood that numerous modifications not having been exemplified can be devised without departing from the scope of the disclosure.

1. an electronic apparatus comprising:
a touch area on a surface of the electronic apparatus;
a fingerprint sensor; and
at least one processor configured to:
execute a first operation of an application;
cause the fingerprint sensor to detect a touch of a finger of a user on the touch area;
cause the fingerprint sensor to obtain a fingerprint of the finger in response to the detection of the touch;
cause the fingerprint sensor to measure a force of the finger to the touch area, and
change the first operation in accordance with the force if the fingerprint is identical to a predetermined fingerprint.

2. The electronic apparatus according to claim 1, wherein
the at least one processer is further configured to
determine whether the force is larger than a predefined value, and
change the first operation to a second operation if the force is larger than the value, and
change the first operation to a third operation if the force is not larger than the value.

3. The electronic apparatus according to claim 1, further comprising a display configured to display a screen, wherein
the at least one processor is further configured to
cause the display to display an object,
move the object at a specified speed as the first operation, and
change the specified speed in accordance with the force.

4. An electronic apparatus comprising:
a touch area on a surface of the electronic apparatus;
a fingerprint sensor; and
at least one processor configured to:
execute an operation of the electronic apparatus;
cause the fingerprint sensor to obtain a fingerprint of a finger on the touch area;
determine an orientation of the fingerprint relative to the electronic apparatus; and
change the operation in accordance with the orientation if the fingerprint is identical to a predetermined fingerprint.

5. The electronic apparatus according to claim 4, further comprising a display configured to display a screen, wherein
the changing the operation includes changing an orientation of the screen.

6. The electronic apparatus according to claim 4, further comprising a display configured to display a first object, wherein
the changing the operation includes changing the first object to a second object displayed in the display.

7. The electronic apparatus according to claim 4, wherein
if the application is a game application, the changing the operation includes changing an orientation of an object to be operated in a game.

8. The electronic apparatus according to claim 4, wherein
the operation is a first processing if the orientation is a first orientation; and
the operation is a second processing if the orientation is a second orientation.

9. The electronic apparatus according to claim 4, wherein
the at least one processor is further configured to
determine a force with which the finger presses against the touch area based on the result of fingerprint detection, and
change the operation to be performed in accordance with the force.

10. The electronic apparatus according to claim 1, wherein
the at least one processor is further configured to
cause the sensor to determine a kind of the finger, and
change the first operation to be performed in accordance with the kind.

11. The electronic apparatus according to claim 4, wherein
the at least one processor is further configured to
determine a kind of the finger touching the touch area based on the result of fingerprint detection, and
change the operation to be performed in accordance with the kind.

12. The electronic apparatus according to claim 1, wherein
the at least one processor is further configured to
detect movement of the finger touching the touch area based on the result of fingerprint detection, and
change the operation to be performed in accordance with the movement.

13. The electronic apparatus according to claim 4, wherein
the at least one processor is further configured to
detect movement of the finger touching the touch area based on the result of fingerprint detection, and
change the operation to be performed in accordance with the movement.

14. The electronic apparatus according to claim 12, wherein
the at least one processor is further configured to change an object selected from a plurality of objects displayed by the electronic apparatus in accordance with the movement.

15. The electronic apparatus according to claim 13, wherein
the at least one processor is further configured to change an object selected from a plurality of objects displayed by the electronic apparatus in accordance with the movement.

16. The electronic apparatus according to claim 12, further comprising a display configured to display a screen, wherein
the at least one processor is further configured to
cause the display to display an object,
move the object to be operated in accordance with the movement.

17. The electronic apparatus according to claim 13, further comprising a display configured to display a screen, wherein
the at least one processor is further configured to
cause the display to display an object,
move the object to be operated in accordance with the movement.

18. The electronic apparatus according to claim 1, further comprising
a push button, wherein
the touch area is included in the push button.

19. The electronic apparatus according to claim 4, further comprising
a push button, wherein
the touch area is included in the push button.

20. The electronic apparatus according to claim 1, wherein
the at least one processor is further configured to
perform user authentication based on the result of fingerprint detection.
